(19) United States
(12) Patent Application Publication
(10) Pub. No.: US 2020/0177774 A1
(43) Pub. Date: Jun. 4, 2020

(54) IMAGING APPARATUS

(71) Applicant: SONY CORPORATION, TOKYO (JP)

(72) Inventors: HIKARU TANOUE, KANAGAWA (JP); DAISHI TANAKA, TOKYO (JP); MASASHI JIMBO, TOKYO (JP); KOICHI ENDO, KANAGAWA (JP); YUKI HARA, TOKYO (JP); HIROKI YOSHIDA, KANAGAWA (JP); MOKUYOH NAKANO, TOKYO (JP)

(21) Appl. No.: 16/615,168

(22) PCT Filed: Apr. 4, 2018
(86) PCT No.: PCT/JP2018/014447

§ 371 Date: Nov. 20, 2019

(30) Foreign Application Priority Data
May 29, 2017 (JP) 2017-105356

(51) Int. Cl. H04N 5/225; H04R 1/02; H04R 1/04

(52) U.S. Cl. CPC H04N 5/2253; H04N 5/2254; H04R 1/04; H04N 5/2252; H04R 1/028; H04N 5/22525

(57) ABSTRACT

To achieve miniaturization while ensuring high functionality. Included are a lens unit that includes at least one lens; an imaging element that performs photoelectric conversion of an optical image of a subject captured by the lens; a battery attachment part to which a battery is attached; a display panel on which an image or video is displayed; a main substrate that controls at least the lens unit; and an antenna substrate having a communication function, in which the lens unit, the battery attachment part, the imaging element, and the display panel are arranged side by side or separately from each other in an optical axis direction of the lens, and in a case where a direction orthogonal to the optical axis direction is defined as an arrangement direction, the main substrate, the lens, and the antenna substrate are arranged side by side or separately from each other in the arrangement direction.

### TECHNICAL FIELD

The present technology relates to the technical field of an imaging apparatus that images a subject by performing photoelectric conversion of an optical image of the subject captured by a lens unit, by means of an imaging element.

### BACKGROUND ART

Among various imaging apparatuses such as a video camera and a still camera, there are imaging apparatuses configured to image a subject by performing photoelectric conversion of an optical image of the subject captured by a lens unit, by means of an imaging element.

An imaging apparatus is often carried and used, and is frequently used also at a destination place in a case where a user goes out. Furthermore, there are an increasing number of types of imaging apparatuses such as an imaging apparatus to be used while being attached to a vehicle, such as a bicycle, and an imaging apparatus having a communication function and being capable of transmitting an image or video to an external device such as a remote-control device or a display device wound around an arm or the like (see, for example, Patent Document 1 and Patent Document 2).

### CITATION LIST

### Patent Document

Patent Document 1: Japanese Patent Application Laid-Open No. 2015-127920
Patent Document 2: Japanese Patent Application Laid-Open No. 2016-122908

### SUMMARY OF THE INVENTION

### Problems to be Solved by the Invention

As described above, the imaging apparatus is often carried and used. Thus, there is seen diversification of usage modes according to scenes or situations such as capturing an image while moving, capturing an image while attached to a vehicle such as a bicycle, and capturing an image while attached to a body. In addition, improvement of functions such as addition of a communication function has also been achieved.

Accordingly, there is a demand for miniaturization from the viewpoints of use in various imaging modes and improvement of portability.

Therefore, an object of an imaging apparatus according to the present technology is to achieve miniaturization while ensuring high functionality.

### Solutions to Problems

First, an imaging apparatus according to the present technology includes: a lens unit that includes at least one lens; an imaging element that performs photoelectric conversion of an optical image of a subject captured by the lens; a battery attachment part to which a battery is attached; a display panel on which an image or video is displayed; a main substrate that controls at least the lens unit; and an antenna substrate having a communication function, in which the lens unit, the battery attachment part, the imaging element, and the display panel are arranged side by side or separately from each other in an optical axis direction of the lens, and in a case where a direction orthogonal to the optical axis direction is defined as an arrangement direction, the main substrate, the lens, and the antenna substrate are arranged side by side or separately from each other in the arrangement direction.

Thus, the substrates of different types are provided. In addition, the main substrate, the lens, and the antenna substrate are arranged side by side or separately from each other in a direction orthogonal to a direction in which the lens unit, the battery attachment part, the imaging element, and the display panel are arranged side by side or separately from each other.

Second, in the imaging apparatus described above, it is preferable that the main substrate and the antenna substrate be disposed opposite to each other across the lens.

Thus, the main substrate and the antenna substrate are located separately from each other to reduce the mutual influence of noise.

Third, in the imaging apparatus described above, it is preferable that the thickness direction of the main substrate be aligned with the arrangement direction.

This reduces a disposition space for the main substrate in the arrangement direction.

Fourth, in the imaging apparatus described above, it is preferable that a plurality of the main substrates be arranged in the arrangement direction, and the plurality of main substrates be connected by a flexible printed wiring board.

Thus, it is possible to increase the areas of the main substrates while preventing an increase in the disposition space for the main substrates in the arrangement direction.

Fifth, in the imaging apparatus described above, it is preferable that a connection terminal be disposed between the plurality of main substrates positioned to face each other.

Thus, the connection terminal is disposed in a space between the main substrates.

Sixth, in the imaging apparatus described above, it is preferable that a plurality of the connection terminals be disposed in a direction orthogonal to the arrangement direction.

Thus, the plurality of connection terminals is disposed between the main substrates without increasing the distance between the main substrates.

Seventh, in the imaging apparatus described above, it is preferable that a case body be provided in which the plurality of main substrates and a plurality of the connection terminals are disposed, and a board terminal unit be formed as a result of disposing at least the plurality of main substrates and the plurality of connection terminals in the case body.

Thus, the plurality of main substrates and the plurality of connection terminals are disposed in the single case body to form the board terminal unit.

Eighth, in the imaging apparatus described above, it is preferable that an electrode terminal to which a terminal of the battery is connected be attached to the case body.

Thus, a part of the board terminal unit functions as a part where the electrode terminal is disposed.

Ninth, in the imaging apparatus described above, it is preferable that a housing be provided in which at least the lens unit, the imaging element, the main substrate, and the antenna substrate are disposed, and the housing be formed in a frame shape.

Thus, the lens unit, the imaging element, the main substrate, and the antenna substrate are disposed inside the housing formed in a frame shape to enhance strength.

Tenth, in the imaging apparatus described above, it is preferable that the battery be formed in a substantially rectangular parallelepiped shape, with a size in a thickness direction smaller than a size in a length direction and a size in a width direction, and the battery be attached to the battery attachment part such that the thickness direction is aligned with the optical axis direction.

This prevents an increase in the disposition space for the battery in the optical axis direction.

Eleventh, in the imaging apparatus described above, it is preferable that a housing be provided which has a battery insertion hole for insertion or removal of the battery, and the battery be inserted into or removed from the battery insertion hole in the arrangement direction.

Thus, the battery is inserted or removed in a direction orthogonal to the thickness direction.

Twelfth, in the imaging apparatus described above, it is preferable that a microphone through which a sound is input and a speaker that outputs a sound be provided, and the microphone and the speaker be disposed opposite to each other across the lens.

Thus, the microphone and the speaker are located separately from each other to reduce the mutual influence of noise.

Thirteenth, in the imaging apparatus described above, it is preferable that the microphone and the speaker be disposed separately from each other in a direction orthogonal to both the optical axis direction and the arrangement direction.

Thus, the microphone and the speaker are disposed at positions orthogonal to the main substrate and the antenna substrate.

Fourteenth, in the imaging apparatus described above, it is preferable that operation parts that are used to perform predetermined functions be disposed on both sides of the lens in a direction orthogonal to both the optical axis direction and the arrangement direction.

Thus, one of the operation parts and the other operation part are disposed at positions orthogonal to the main substrate and the antenna substrate, so that the one of the operation parts and the other operation part do not interfere with the main substrate and the antenna substrate.

Fifteenth, in the imaging apparatus described above, it is preferable that a coupling part be formed to which a coupling protrusion of a tripod is coupled, and the center of gravity be located on a central axis of the coupling part.

Thus, the center of gravity is located on the axis of the coupling protrusion.

Sixteenth, in the imaging apparatus described above, it is preferable that an imaging element having a size corresponding to 1/1.7 type or APS-C type be used as the imaging element.

Thus, the number of pixels of the imaging element increases.

### Effects of the Invention

According to the present technology, substrates of different types are provided. In addition, the main substrate, the lens, and the antenna substrate are arranged side by side or separately from each other in a direction orthogonal to a direction in which the lens unit, the battery attachment part, the imaging element, and the display panel are arranged side by side or separately from each other. It is thus possible to achieve miniaturization while ensuring high functionality.

Note that the effects described in the present specification are merely illustrative and not restrictive, and other effects may be achieved.

### BRIEF DESCRIPTION OF DRAWINGS

FIG. 1 is a perspective view of an imaging apparatus according to the present technology, and shows an embodiment of the imaging apparatus together with FIGS. 2 to 25.

FIG. 2 is a perspective view of the imaging apparatus seen from a direction different from FIG. 1.

FIG. 3 is an exploded perspective view of the imaging apparatus.

FIG. 4 is an enlarged perspective view of a housing.

FIG. 5 is an enlarged perspective view of the housing seen from a direction different from FIG. 4.

FIG. 6 is an exploded perspective view of an internal unit.

FIG. 7 is an enlarged perspective view of a lens unit and the like.

FIG. 8 is an enlarged perspective view of the lens unit, a board terminal unit, a holding member, and the like.

FIG. 9 is an enlarged perspective view of the board terminal unit and the like.

FIG. 10 is an enlarged perspective view of a battery attachment part to which a battery has been attached.

FIG. 11 is an enlarged front view of an internal structure.

FIG. 12 is an enlarged horizontal sectional view of the imaging apparatus.

FIG. 13 is a block diagram showing a hardware configuration of the imaging apparatus.

FIG. 14 is a chart showing recording modes and the like that can be taken in the imaging apparatus.

FIG. 15 is a perspective view of the imaging apparatus and a cable holder detached from each other.

FIG. 16 is a perspective view of the imaging apparatus to which the cable holder has been attached.

FIG. 17 is a perspective view of the cable holder.

FIG. 18 is a perspective view of the cable holder seen from a direction different from FIG. 17.

FIG. 19 is an exploded perspective view of the cable holder.

FIG. 20 is a perspective view of the cable holder uncapped and attached to the imaging apparatus, and a tripod detached from the cable holder.

FIG. 21 is a perspective view of the cable holder holding a cable.

FIG. 22 is a perspective view of a rig.

FIG. 23 is a perspective view of the rig to which the cable holder has been attached.

FIG. 24 is a perspective view of the rig to which a plurality of the cable holders has been attached.

FIG. 25 is a perspective view of the rig to which the plurality of cable holders has been attached while being stacked.

### MODE FOR CARRYING OUT THE INVENTION

Modes for carrying out the present technology will be described below with reference to the accompanying drawings.

An embodiment described below is an application of an imaging apparatus according to the present technology to a still camera. Note that the application range of the imaging apparatus according to the present technology is not limited to a still camera, and the imaging apparatus according to the present technology can be widely applied to various other imaging apparatuses such as a video camera.

Directions as seen from an image capturing person are described as forward, backward, up, down, left, and right in the following description. Accordingly, the subject side is forward, and the image capturing person side is backward.

Note that directions are described below as forward, backward, up, down, left, and right for the convenience of description, and implementation of the present technology is not limited to these directions.

<Configuration and the Like of Imaging Apparatus>

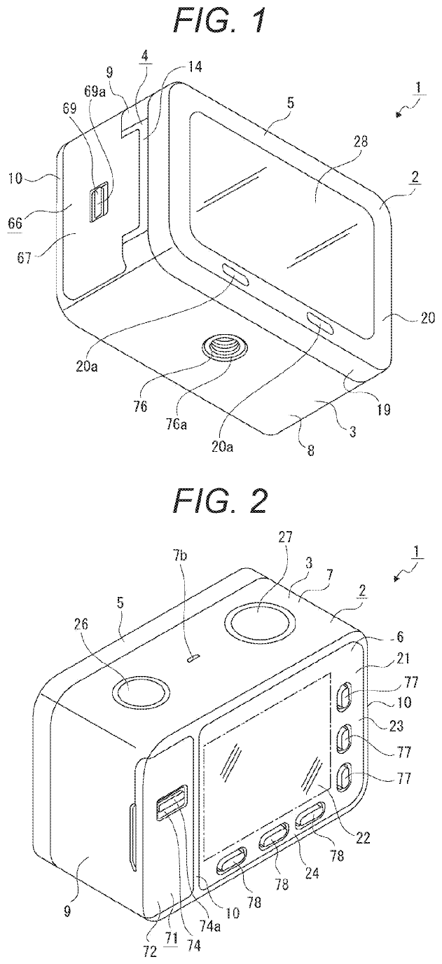

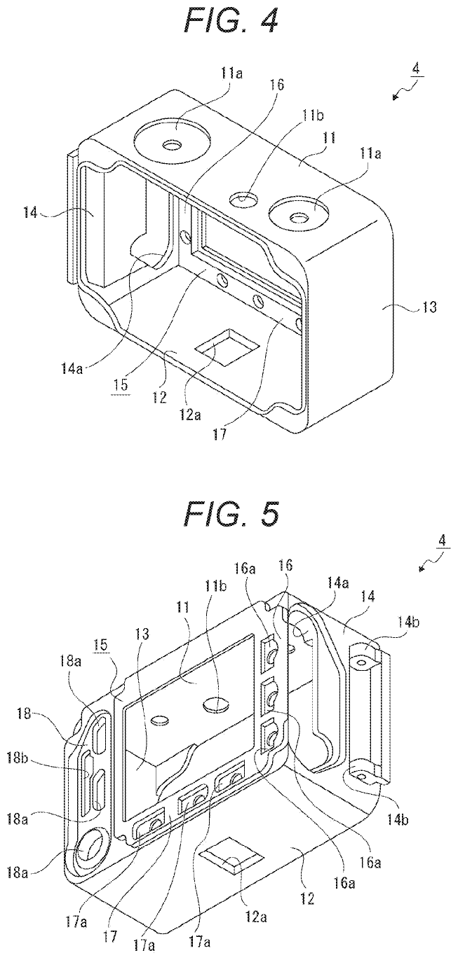

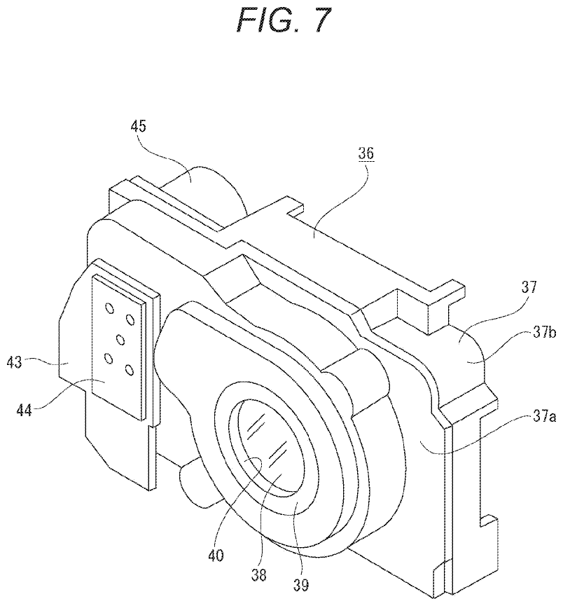

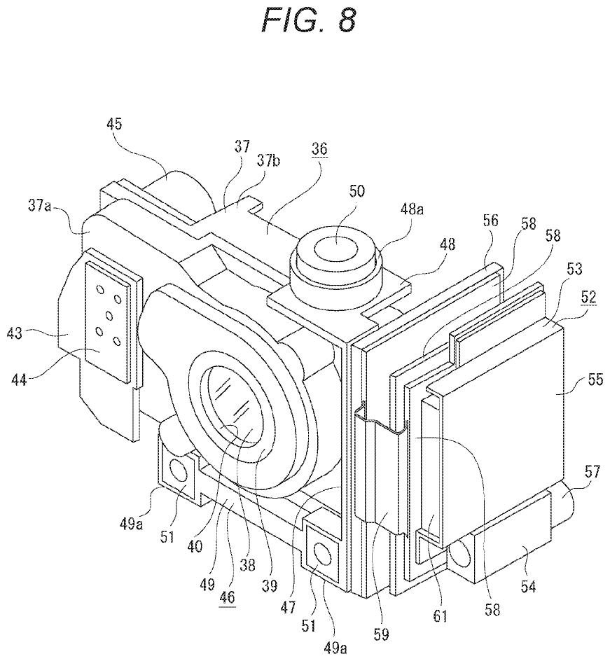

First, the configuration and the like of the imaging apparatus will be described (see FIGS. 1 to 12).

An imaging apparatus 1 is formed in, for example, a long sideways and substantially rectangular parallelepiped shape, and includes each necessary part disposed inside/outside a cabinet 2 (see FIGS. 1 to 3). The cabinet 2 includes an outer housing 3, a housing 4, a frame 5, and a rear panel 6. Note that the imaging apparatus 1 may be an apparatus to/from which an interchangeable lens (not shown) can be attached/detached. Alternatively, the imaging apparatus 1 may be an apparatus to/from which an interchangeable lens is not attached/detached.

The outer housing 3 has an upper surface 7, a lower surface 8, and a side surface 9. The upper surface 7 and the lower surface 8 are connected by the side surface 9 and connection parts 10 and 10. Operation part disposition holes 7a and 7a are formed in the upper surface 7 such that the operation part disposition holes 7a and 7a are separated from each other in the left-right direction. An audio output hole 7b is formed in the upper surface 7 such that the audio output hole 7b is located between the operation part disposition holes 7a and 7a. A protrusion insertion hole 8a is formed in the lower surface 8, at the center in the left-right direction. The upper surface 7 and the lower surface 8 are connected to each other by the side surface 9 at one end in the left-right direction and by the connection part 10 on the rear side at the other end in the left-right direction. In addition, the upper surface 7 and the lower surface 8 are also connected to each other by the other connection part 10 located on the rear side near the side surface 9.

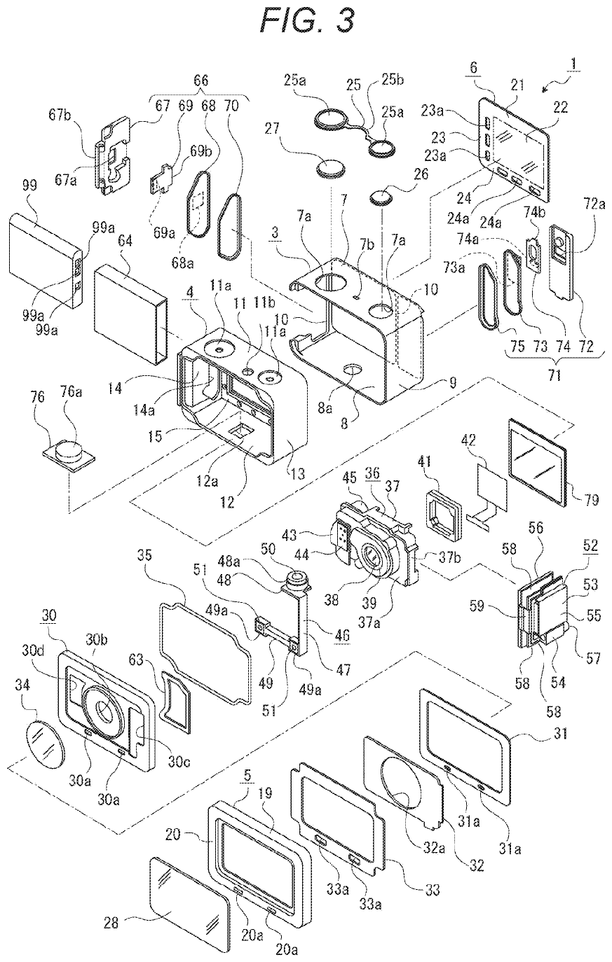

The housing 4 is formed in a substantially frame shape such that the housing 4 is penetrated in the front-back direction, and includes a top plate 11, a bottom plate 12, a side plate 13, a side support part 14, and a frame part 15 (see FIGS. 3 to 5). Disposition recesses 11a and 11a opening upward are formed in the top plate 11 such that the disposition recesses 11a and 11a are separated from each other in the left-right direction. A sound hole 11b is formed in the top plate 11 such that the sound hole 11b is located between the disposition recesses 11a and 11a. An insertion hole 12a is formed in the bottom plate 12, at the center in the left-right direction.

The top plate 11 and the bottom plate 12 are connected to each other at their left and right ends by the side plate 13 and the side support part 14, respectively. A battery insertion hole 14a which is vertically long is formed in the rear part of the side support part 14 such that the battery insertion hole 14a is penetrated in the left-right direction. Support protrusions 14b and 14b are provided on the outer surface of the side support part 14 such that the support protrusions 14b and 14b are vertically separated from each other.

The frame part 15 is formed in a substantially rectangular frame shape. The upper and lower ends of the frame part 15 are continuous with the rear end of the top plate 11 and the rear end of the bottom plate 12, respectively. The frame part 15 is continuous with the top plate 11 and the bottom plate 12 except the left end of the top plate 11 and the left end of the bottom plate 12. Thus, the left end of the frame part 15 is located to the right, away from the side plate 13. Each part of the frame part 15 is formed in a plate shape facing in the front-back direction. In addition, button disposition parts 16a, 16a, and 16a and button disposition parts 17a, 17a, and 17a are formed in a side part 16 on the side support part 14 side and a lower part 17, respectively. The button disposition parts 16a, 16a, and 16a are vertically separated from each other, and the button disposition parts 17a, 17a, and 17a are separated from each other in the left-right direction.

The housing 4 includes a terminal disposition part 18 provided between the frame part 15 and the rear end of the side plate 13. Terminal disposition holes 18a, 18a, and 18a and a card insertion hole 18b are formed in the terminal disposition part 18 such that the terminal disposition holes 18a, 18a, and 18a and the card insertion hole 18b are penetrated in the front-back direction. The terminal disposition holes 18a, 18a, and 18a are vertically separated from each other, and the card insertion hole 18b is located at the side of the terminal disposition holes 18a and 18a.

The outer housing 3 is attached to the outside of the housing 4. While the outer housing 3 is kept attached to the housing 4, the top plate 11, the bottom plate 12, and the side plate 13 of the housing 4 are covered with the upper surface 7, the lower surface 8, and the side surface 9 of the outer housing 3, respectively.

The frame 5 is formed in a long sideways and substantially rectangular frame shape, and has a circumferential surface 19 facing in the vertical direction or the left-right direction and an inner flange 20 inwardly protruding from the front edge of the circumferential surface 19. Audio input holes 20a and 20a are formed in the lower part of the inner flange 20 such that the audio input holes 20a and 20a are separated from each other in the left-right direction. The frame 5 is attached to the front edge of the housing 4 from the front side.

The rear panel 6 is formed in a substantially rectangular flat plate shape facing in the front-back direction. The outer peripheral part of the rear panel 6 is provided as a shielding part 21 having no light permeability. The inner part of the shielding part 21 is provided as a light transmission part 22 having light permeability. Button disposition holes 23a, 23a, and 23a and button disposition holes 24a, 24a, and 24a are formed in a side part 23 on either the left or right side of the light transmission part 22 and a lower part 24 thereof, respectively. The button disposition holes 23a, 23a, and 23a are vertically separated from each other, and the button disposition holes 24a, 24a, and 24a are separated from each other in the left-right direction.

An operation part frame 25 is disposed in the disposition recesses 11a and 11a formed in the top plate 11 of the housing 4. The operation part frame 25 includes annular support parts 25a and 25a and a coupling bar 25b. The annular support parts 25a and 25a are separated from each other in the left-right direction. The coupling bar 25b couples the annular support parts 25a and 25a. The operation part frame 25 is disposed such that the annular support parts 25a and 25a are respectively disposed on the outer peripheral parts of the disposition recesses 11a and 11a.

A power button 26 and an imaging button 27 are respectively supported on the annular support parts 25a and 25a of the operation part frame 25. The power button 26 and the imaging button 27 are disposed such that the power button 26 and the imaging button 27 are respectively inserted into the operation part disposition holes 7a and 7a of the outer housing 3 and supported by the annular support parts 25a and 25a. The power can be turned on or off according to an operation on the power button 26, and a subject can be imaged according to an operation on the operation button 27.

A protective plate 28 is attached to the frame 5. The protective plate 28 is formed in a substantially rectangular shape which is slightly smaller than the frame 5, with a transparent material such as glass or resin. The outer peripheral part of the protective plate 28 is attached, by adhesion or the like, to the inner peripheral part of the frame 5 from the front side. Note that the frame 5 to which the protective plate 28 has been attached is screwed onto a base cabinet 30 from the front side at its four corners in an attachable and detachable manner. Thus, it is possible to detach the frame 5 from the base cabinet 30 by getting screws out and to attach a filter adapter (not shown) to the base cabinet 30 instead of the frame 5. A circular hole having a central axis aligned with the optical axis of a lens 38 is formed in the center of the filter adapter. At an opening edge of the circular hole, there is formed a spiral groove that enables attachment of a filter having a diameter of, for example, 30.5 mm. Thus, a user can attach a desired filter to the filter adapter by screwing the desired filter into the spiral groove.

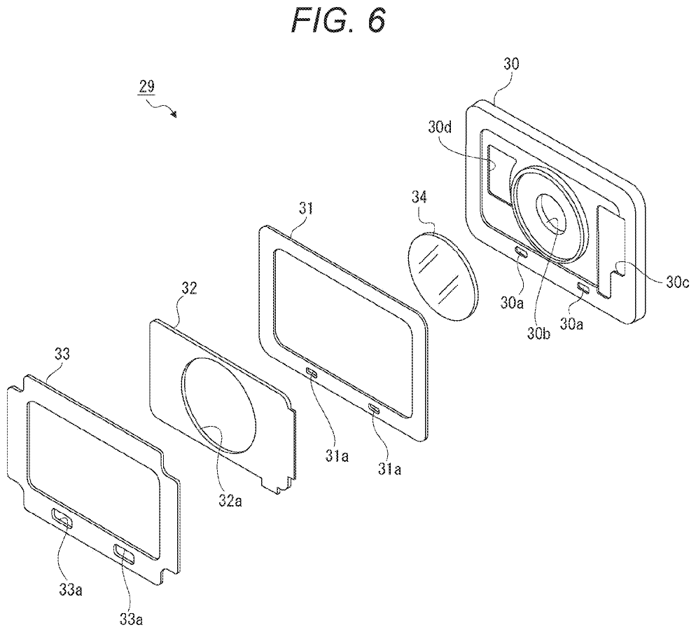

An internal unit 29 is attached to the front of the housing (see FIGS. 3 and 6). The internal unit 29 includes the base cabinet 30, a frame plate 31, a sub cabinet 32, and a packing 33.

The base cabinet 30 is formed in a long sideways and substantially rectangular shape. Sound holes 30a and 30a are formed in the lower part of the base cabinet 30 such that the sound holes 30a and 30a are separated from each other in the left-right direction. A transmission hole 30b is formed in the center of the base cabinet 30 such that the transmission hole 30b is penetrated in the front-back direction. A first opening 30c and a second opening 30d are respectively formed in the left side and the right side of the transmission hole 30b of the base cabinet 30 such that the first opening 30c and the second opening 30d are penetrated in the front-back direction.

A light transmission plate 34 is attached to the base cabinet 30 in such a way as to cover the transmission hole 30b from the front side. The light transmission plate 34 is formed in a substantially disc shape with a transparent material such as glass.

The frame plate 31 is formed in a frame shape, and is attached to the outer peripheral part of the base cabinet 30. Sound passing holes 31a and 31a are formed in the lower part of the frame plate 31 such that the sound passing holes 31a and 31a are separated from each other in the left-right direction.

The sub cabinet 32 is formed in a long sideways and substantially rectangular shape, and is slightly smaller than the base cabinet 30. An opening 32a having a circular shape is formed in the center of the sub cabinet 32 such that the opening 32a is penetrated in the front-back direction. The sub cabinet 32 is attached to the base cabinet 30 from the front side while being disposed in the frame plate 31. The light transmission plate 34 is disposed while being inserted in the opening 32a of the sub cabinet 32 attached to the base cabinet 30. Note that the base cabinet 30 and the sub cabinet 32 may be integrally formed by, for example, injection molding. It is possible to reduce the manufacturing cost and the number of parts of the imaging apparatus 1 by integrally forming the base cabinet 30 and the sub cabinet 32.

The packing 33 is formed in a frame shape, and is attached to the outer peripheral part of the base cabinet 30 while being in contact with the front surface of the frame plate 31. Passing holes 33a and 33a are formed in the lower part of the packing 33 such that the passing holes 33a and 33a are separated from each other in the left-right direction.

The internal unit 29 is attached to the front of the housing 4 with a packing 35 having an annular shape interposed therebetween. Accordingly, the packing 35 makes the space between the internal unit 29 and the housing 4 waterproof.

The frame 5 is attached to the front edge of the housing 4 from the front side after the internal unit 29 is attached to the front of the housing 4. Therefore, the internal unit 29 is covered, from the front side, with the frame 5 and the protective plate 28 attached to the frame 5.

A lens unit 36 is disposed inside the housing 4 (see FIGS. 3, 7, and 8). The lens unit 36 includes a unit case 37, at least one lens 38, for example, a plurality of the lenses 38, 38, . . . , and a lens holder 39.

The unit case 37 includes a front panel 37a and a rear panel 37b coupled in the front-back direction.

The lens holder 39 is formed in a substantially cylindrical shape with its axis aligned with the front-back direction (optical axis direction) such that the space inside the lens holder 39 serves as a light passing hole 40. The lens holder 39 is disposed inside the unit case 37. At least the front edge of the lens holder 39 is attached to the front panel 37a. The lenses 38, 38, . . . are arranged inside the lens holder 39 in such a way as to be movable or immovable in the front-back direction (optical axis direction). Note that the unit case 37 or the lens holder 39 may support an iris, a shutter, or the like (not shown).

An attachment frame 41 formed in a substantially rectangular frame shape is attached to the rear surface of the rear panel 37b. The attachment frame 41 includes, for example, a sealing cushion, sealing members, and a packing. An optical element (not shown), such as an infrared cut filter, and an imaging element 42 are disposed on the rear side of the rear panel 37b. A charge coupled device (CCD), a complementary metal-oxide semiconductor (CMOS), or the like is used as the imaging element 42. For example, a 1-inch CMOS is used as the imaging element 42.

An attachment base 43 is attached to the front surface of the right end of the front panel 37a. An antenna substrate 44 is attached to the front surface of the attachment base 43.

The antenna substrate 44 is formed in a vertically long and substantially rectangular shape, with its thickness direction aligned with the front-back direction. The antenna substrate 44 is a substrate for performing communication such as wireless communication between the imaging apparatus 1 and an external device (not shown). Therefore, for example, an image or video taken by the imaging apparatus 1 is displayed on the display unit of the external device by the communication function of the antenna substrate 44. Alternatively, the imaging apparatus 1 is operated on the basis of an operation signal transmitted from the external device, so that various operations such as an imaging operation are performed. The antenna substrate 44 is located on the right of the lenses 38, 38, . . . .

A drive motor 45 is attached to the rear surface of the right end of the rear panel 37b. The drive motor 45 operates to move, for example, the lens holder 39 in the front-back direction.

A holding member 46 is attached to the lens unit 36 (see FIGS. 3, 8, and 9). The holding member 46 includes a base leg 47, an upper holding part 48, and a lower holding part 49. The base leg 47 extends vertically. The upper holding part 48 protrudes rightward from the upper end of the base leg 47. The lower holding part 49 protrudes rightward from the lower end of the base leg 47. A speaker disposition part 48a having a recess opening upward is provided on the upper holding part 48. Microphone disposition parts 49a and 49a having recesses opening forward are respectively provided on the left and right ends of the lower holding part 49.

The holding member 46 is attached to the lens unit 36 such that the base leg 47 is along the front surface at the left end of the front panel 37a, the upper holding part 48 is located above the upper surface of the front panel 37a, and the lower holding part 49 is along the front surface at the lower end of the front panel 37a. A speaker 50 is disposed in the speaker disposition part 48a of the holding member 46, and microphones 51 and 51 are respectively disposed in the microphone disposition parts 49a and 49a of the holding member 46.

The speaker 50 is located directly below the sound hole 11b of the housing 4 and the audio output hole 7b of the outer housing 3. The microphones 51 and 51 are located directly behind the audio input holes 20a and 20a of the frame 5, and the passing holes 33a and 33a, the sound passing holes 31a and 31a, and the sound holes 30a and 30a of the internal unit 29, respectively. Therefore, a sound output from the speaker 50 goes outside through the sound hole 11b of the housing 4 and the audio output hole 7b of the outer housing 3. In addition, an external sound is input to the microphones 51 and 51 through the audio input holes 20a and 20a of the frame 5, and the passing holes 33a and 33a, the sound passing holes 31a and 31a, and the sound holes 30a and 30a of the internal unit 29.

A board terminal unit 52 is disposed on the left side of the lens unit 36 (see FIGS. 3, 8, 9, and 10). The board terminal unit 52 includes a case body 53 and each part held inside/outside the case body 53.

The case body 53 includes a base member 54, a cover plate 55, and a backing plate 56. The base member 54 is located in the lower part of the case body 53. A microphone terminal 57 is held by the base member 54. A part of the microphone terminal 57 protrudes backward from the base member 54. The cover plate 55 is formed in a shape having a box-like portion opening to the right, and is located above the base member 54. The backing plate 56 is formed such that the backing plate 56 is oriented in the left-right direction and extends vertically. The backing plate 56 is located to the right of the base member 54 and the cover plate 55.

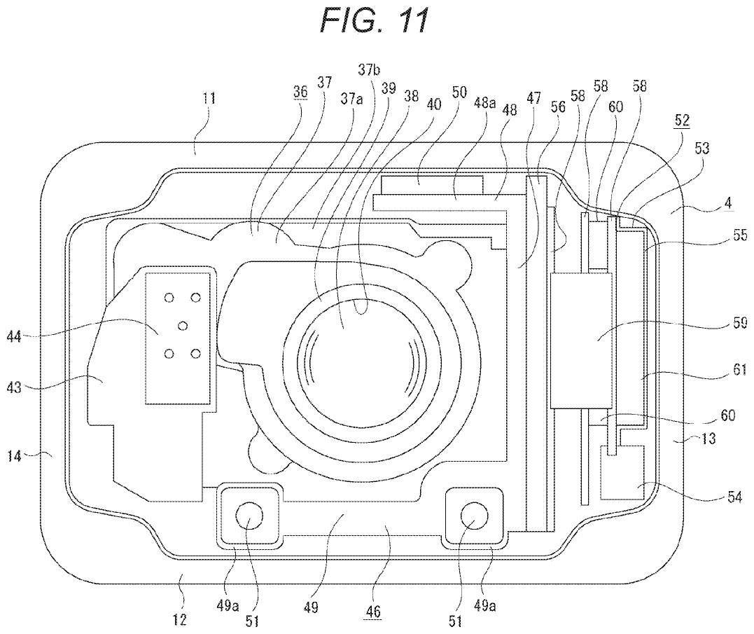

Main substrates 58, 58, and 58 are disposed inside the case body 53 such that the main substrates 58, 58, and 58 are separated from each other in the left-right direction. The main substrates 58, 58, and 58 are located to the left of the lenses 38, 38, . . . , and the antenna substrate 44 is located to the right of the lenses 38, 38, . . . as described above (see FIG. 11).

Therefore, in the imaging apparatus 1, the main substrates 58, 58, and 58 and the antenna substrate 44, which are substrates having different functions, are located opposite to each other across the lenses 38, 38, . . . in the left-right direction. A direction in which the main substrates 58, 58, and 58, the lenses 38, 38, . . . , and the antenna substrate 44 are arranged is defined as an arrangement direction. The arrangement direction corresponds to the left-right direction, that is, a direction orthogonal to the optical axis direction that corresponds to the front-back direction.

The main substrate 58 is disposed with its thickness direction aligned with the left-right direction, that is, the direction orthogonal to the optical axis direction. The main substrate 58 has a function of performing various types of control on each part of the imaging apparatus 1, such as power supply control, image processing control, recording/reproducing control, detection control at the time of operation for various operation parts, and control on the drive motor 45.

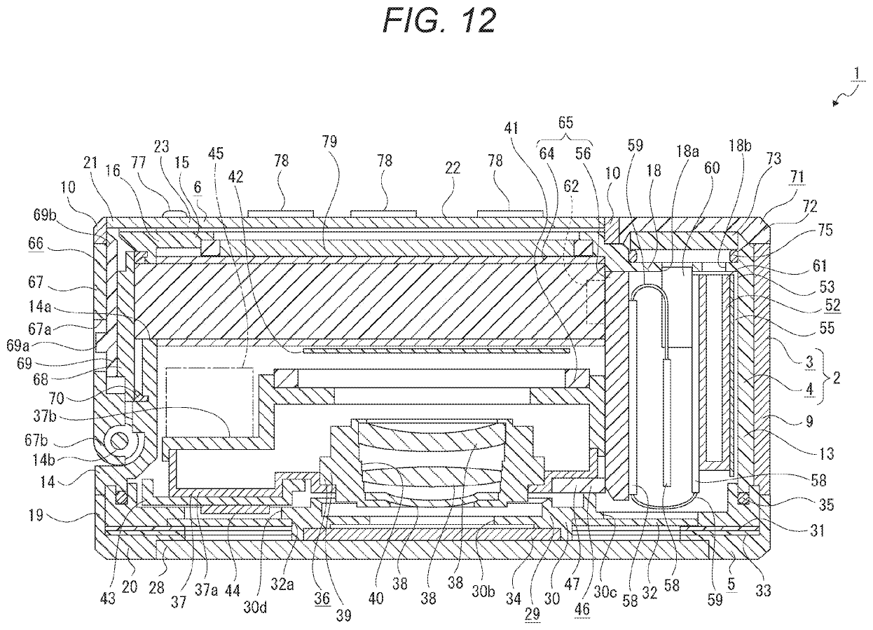

The main substrates 58, 58, and 58 are connected by flexible printed wiring boards 59 and 59. For example, as shown in FIG. 12, the main substrate 58 located at the center in the left-right direction and the main substrate 58 located at the leftmost position are connected by the flexible printed wiring board 59, and the main substrate 58 located on the leftmost position and the main substrate 58 located at the rightmost position are connected by the other flexible printed wiring board 59.

Note that although an example of providing the three main substrates 58 has been described above, the number of the main substrates 58 to be provided in the imaging apparatus 1 is arbitrary. Furthermore, in the case of providing a plurality of the main substrates 58, 58, . . . , the plurality of main substrates 58, 58, . . . may be connected by the flexible printed wiring boards 59, 59, . . . in any desired state. For example, the adjacent main substrates 38, 38, . . . may be sequentially connected by the flexible printed wiring boards 59, 59, . . . .

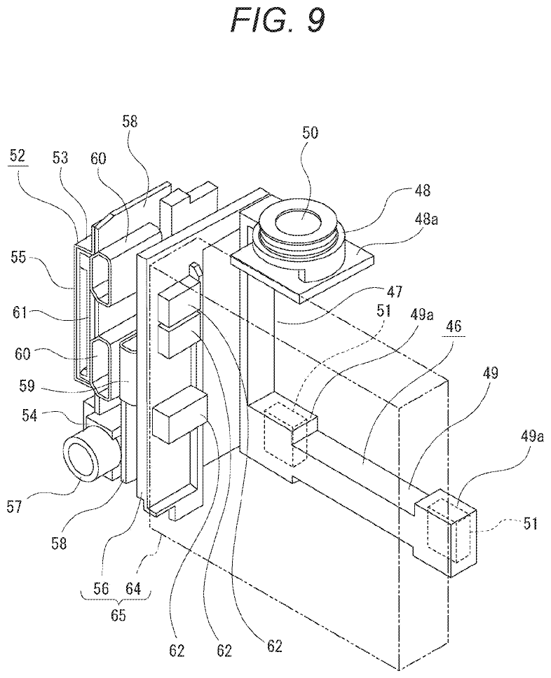

Connection terminals 60 and 60 are located between the main substrates 58 and 58 such that the connection terminals 60 and 60 are vertically separated from each other (see FIGS. 9, 10, and 12). Connection terminals capable of transmitting, for example, an image (video) signal or an audio signal as a digital signal are used as the connection terminals 60 and 60. Examples of such connection terminals include a high-definition multimedia interface (HDMI) terminal and a universal serial bus (USB) terminal.

A card slot 61 is disposed inside the case body 53 such that the card slot 61 is located between the cover plate 55 and the leftmost main substrate 58. A recording card (not shown) for recording a captured image or the like is inserted into/removed from the card slot 61.

Electrode terminals 62, 62, and 62 are attached to the right side surface of the backing plate 56 such that the electrode terminals 62, 62, and 62 are vertically separated from each other.

The microphone terminal 57, the connection terminals 60 and 60, the card slot 61, and the electrode terminals 62, 62, and 62 are each connected to the main substrates 58, 58, and 58 by a wiring board or the like (not shown). Furthermore, the power button 26, the imaging button 27, the speaker 50, and the microphones 51 and 51 described above are also each connected to the main substrates 58, 58, and 58 by a wiring board or the like (not shown).

The board terminal unit 52 is disposed inside the housing 4 together with the lens unit 36, the imaging element 42, and the antenna substrate 44. While being disposed inside the housing 4, the connection terminals 60 and 60 and the microphone terminal 57 are respectively inserted into the terminal disposition holes 18a, 18a, and 18a of the housing 4 from the rear, and the card slot 61 is inserted into the card insertion hole 18b from the rear.

A frame-shaped electrostatic plate 63 is attached to the base cabinet 30 from the rear (see FIG. 3).

As described above, the thickness direction of the main substrates 58, 58, and 58 is aligned with the arrangement direction, that is, the direction in which the lenses 38, 38, . . . , the main substrates 58, 58, and 58, and the antenna substrate 44 are arranged in the imaging apparatus 1.

Therefore, the disposition space for the main substrates 58, 58, and 58 in the arrangement direction is reduced. This enables the imaging apparatus 1 to be miniaturized in the arrangement direction.

Furthermore, the plurality of main substrates 58, 58, and 58 is arranged side by side in the arrangement direction. In addition, the main substrates 58, 58, and 58 are connected by the flexible printed wiring boards 59 and 59.

Accordingly, it is possible to increase the areas of the main substrates 58, 58, and 58 while preventing an increase in the disposition space for the main substrates 58, 58, and 58 in the arrangement direction. As a result, it is possible to miniaturize the imaging apparatus 1 in the arrangement direction while improving the functionality of the main substrates 58, 58, and 58.

Moreover, the connection terminals 60 and 60 are disposed between the main substrates 58 and 58 positioned to face each other.

Therefore, as a result of disposing the connection terminals 60 and 60 in the space between the main substrates 58 and 58, the imaging apparatus 1 can be miniaturized in the arrangement direction due to effective use of space.

In addition, the plurality of connection terminals 60 and 60 is disposed between the main substrates 58 and 58 positioned to face each other, in a direction (vertical direction) orthogonal to the arrangement direction.

Therefore, as a result of disposing the plurality of connection terminals 60 and 60 between the main substrates 58 and 58 without increasing the distance between the main substrates 58 and 58, it is possible to miniaturize the imaging apparatus 1 in the arrangement direction due to effective use of space while improving functionality by disposing the plurality of connection terminals 60 and 60.

Furthermore, provided is the case body 53 for disposing the plurality of main substrates 58, 58, and 58 and the plurality of connection terminals 60 and 60. The board terminal unit 52 is formed as a result of disposing at least the plurality of main substrates 58, 58, and 58 and the plurality of connection terminals 60 and 60 in the case body 53.

Thus, the plurality of main substrates 58, 58, and 58 and the plurality of connection terminals 60 and 60 are disposed in the single case body 53 to form the board terminal unit 52. As a result, it is possible to protect the plurality of main substrates 58, 58, and 58 and the plurality of connection terminals 60 and 60 with a small number of parts.

A battery holder 64 is disposed on the rear side of the inside of the housing 4 (see FIGS. 3, 10, and 12). The battery holder 64 is formed in a flat box shape opening to the left and right, with a size in the front-back direction smaller than sizes in the vertical direction and the left-right direction. The left end of the battery holder 64 is attached to the backing plate 56 of the board terminal unit 52. As a result of attaching the battery holder 64 to the backing plate 56, the battery holder 64 and the backing plate 56 form a battery attachment part 65, and the electrode terminals 62, 62, and 62 attached to the backing plate 56 are located inside the battery holder 64. The battery holder 64 is located on the rear side of the imaging element 42.

A battery cover 66 is supported by the side support part 14 of the housing 4 in a rotatable manner (openable and closable manner) (see FIGS. 1 and 3). The battery cover 66 is supported by the support protrusions 14b and 14b of the side support part 14. The battery cover 66 includes a cover main body 67, a pressing support plate 68, a lock slider 69, and an annular packing 70.

An insertion disposition hole 67a is formed in the cover main body 67. A supported protrusion 67b is provided at one end of the cover main body 67.

The pressing support plate 68 is coupled to the inner surface of the cover main body 67, and includes a slider support part 68a provided on a surface facing the cover main body 67.

An operation protrusion 69a is provided on the lock slider 69. The lock slider 69 is movably supported by the slider support part 68a between the cover main body 67 and the pressing support plate 68. An engagement part 69b is provided at one end of the lock slider 69 in a moving direction. While the lock slider 69 is supported by the slider support part 68a, the operation protrusion 69a is inserted into the insertion disposition hole 67a of the cover main body 67. The lock slider 69 is biased by a spring (not shown) to one side in the moving direction.

The annular packing 70 is attached to the outer peripheral part of a surface of the pressing support plate 68 opposite to the side on which the lock slider 69 is supported.

The supported protrusion 67b of the cover main body 67 of the battery cover 66 is supported by the support protrusions 14b and 14b of the housing 4. While the battery cover 66 is closed with respect to the housing 4, the lock slider 69 is located at one moving end in the moving direction by the biasing force of the spring, and the engagement part 69b is engaged with a lock engagement part (not shown) of the housing 4. Accordingly, the battery cover 66 is kept closed with respect to the housing 4.

When the battery cover 66 is in the closed state, the annular packing 70 is pressed against the opening edge of the battery insertion hole 14a of the housing 4 to make the space between the battery cover 66 and the housing 4 waterproof. Note that the annular packing 70 may be attached to the opening edge of the battery insertion hole 14a.

Meanwhile, if a user operates the operation protrusion 69a when the battery cover 66 is in the closed state, the lock slider 69 is slid against the biasing force of the spring to disengage the engagement part 69b from the lock engagement part. Therefore, as a result of rotating the battery cover 66 such that the battery cover 66 comes into an open state, the battery insertion hole 14a of the housing 4 is made open, so that a battery 99 can be inserted into/removed from the battery holder 64.

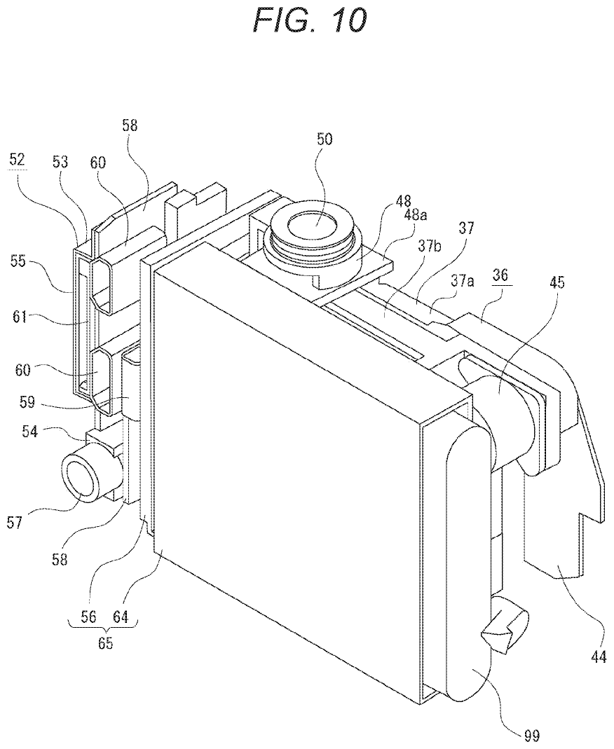

The battery 99 is formed in a flat and substantially rectangular parallelepiped shape corresponding to the battery holder 64, with a size in a thickness direction smaller than a size in a length direction and a size in a width direction. The battery 99 is attached to the battery attachment part 65 such that the thickness direction of the battery 99 is aligned with the front-back direction, that is, the optical axis direction (see FIG. 10). Terminals 99a, 99a, and 99a are provided on an end surface of the battery 99 facing in a direction in which the battery 99 is inserted into the battery holder 64.

While the battery 99 is kept attached to the battery attachment part 65, the terminals 99a, 99a, and 99a are connected to the electrode terminals 62, 62, and 62 attached to the backing plate 56, respectively. Therefore, power can be supplied from the battery 99 to each part of the imaging apparatus 1.

As a result of rotating the battery cover 66 such that the battery cover 66 comes into the closed state while the battery 99 is kept attached to the battery attachment part 65, an end surface of the battery 99 opposite to the side on which the terminals 99a, 99a, and 99a are provided is pressed from the right by the pressing support plate 68 of the battery cover 66. This ensures stable attachment of the battery 99 to the battery attachment part 65.

As described above, there are disposed, on the case body 53, the electrode terminals 62, 62, and 62 to which the terminals 99a, 99a, and 99a of the battery 99 are connected, in the imaging apparatus 1.

Thus, a part of the board terminal unit 52 functions as a portion for disposing the electrode terminals 62, 62, and 62. Accordingly, it is not necessary to provide a dedicated disposition part for disposing the electrode terminals 62, 62, and 62. It is thus possible to reduce the number of parts of the imaging apparatus 1 and miniaturize the imaging apparatus 1.

Furthermore, the battery 99 is formed in a substantially rectangular parallelepiped shape, with the size in the thickness direction smaller than the size in the length direction and the size in the width directions. In addition, the battery 99 is attached to the battery attachment part 65 such that the thickness direction of the battery 99 is aligned with the optical axis direction.

This prevents an increase in disposition space for the battery 99 in the optical axis direction in the imaging apparatus 1. As a result, it is possible to miniaturize the imaging apparatus 1 in the optical axis direction while securing a disposition space for the battery 99.

Moreover, provided is the housing 4 having the battery insertion hole 14a for inserting or removing the battery 99. Thus, the battery 99 is inserted into/removed from the battery insertion hole 14a in the arrangement direction.

Accordingly, the battery 99 is inserted or removed in a direction orthogonal to the thickness direction. This reduces the opening area of the battery insertion hole 14a. As a result, it is possible to enhance the rigidity of the housing 4 and improve the strength of the imaging apparatus 1.

A terminal cover 71 is attachable to/detachable from the terminal disposition part 18 of the housing 4 (see FIGS. 2 and 3). The terminal cover 71 includes a cover main body 72, a pressing support plate 73, a lock slider 74, and an annular packing 75.

An insertion disposition hole 72a is formed in the cover main body 72 such that the insertion disposition hole 72a is penetrated in the front-back direction.

The pressing support plate 73 is coupled to the cover main body 72, and includes a slider support part 73a provided on a surface facing the cover main body 72.

An operation protrusion 74a protruding backward is provided on the lock slider 74. The lock slider 74 is movably supported by the slider support part 73a between the cover main body 72 and the pressing support plate 73. An engagement part 74b is provided at one end of the lock slider 74 in a moving direction. While the lock slider 74 is supported by the slider support part 73a, the operation protrusion 74a is inserted into the insertion disposition hole 72a of the cover main body 72. The lock slider 74 is biased by a spring (not shown) to one side in the moving direction.

The annular packing 75 is attached to the outer peripheral part of a surface of the pressing support plate 73 opposite to the side on which the lock slider 74 is supported.

While the terminal cover 71 is closed to cover the terminal disposition part 18, the lock slider 74 is located at one moving end in the moving direction by the biasing force of a spring, and the engagement part 74b is engaged with a lock engagement part (not shown) of the housing 4. Accordingly, the terminal cover 71 is kept closed with respect to the housing 4.

When the terminal cover 71 is in the closed state, the annular packing 75 is pressed against the outer peripheral part of the terminal disposition part 18 to make the space between the terminal cover 71 and the terminal disposition part 18 waterproof. At this time, the terminal disposition holes 18a, 18a, and 18a and the card insertion hole 18b are covered from behind with the terminal cover 71, so that the microphone terminal 57, the connection terminals 60 and 60, and the card slot 61 are protected.

Meanwhile, if a user operates the operation protrusion 74a when the terminal cover 71 is in the closed state, the lock slider 74 is slid against the biasing force of the spring to disengage the engagement part 74b from the lock engagement part. Therefore, as a result of removing the terminal cover 71 from the housing 4, the terminal disposition holes 18a, 18a, and 18a and the card insertion hole 18b of the housing 4 are made open, so that a connector terminal (not shown) can be connected to the microphone terminal 57 or the connection terminal 60 or 60, and that a recording card can be inserted into the card slot 61.

A connecting member 76 is attached to the upper surface of the bottom plate 12 of the housing 4 (see FIG. 3). The connecting member 76 includes a coupling part 76a opening at least downward. A spiral groove is formed in the inner peripheral surface of the coupling part 76a. The connecting member 76 is attached to the bottom plate 12 such that the coupling part 76a is located directly above the insertion hole 12a formed in the bottom plate 12. A coupling protrusion of a tripod or the like inserted into the insertion hole 12a is coupled to the coupling part 76a of the connecting member 76. The center of gravity of the imaging apparatus 1 is located on the central axis of the coupling part 76a.

As described above, the center of gravity is located on the central axis of the coupling part 76a, to which the coupling protrusion of a tripod or the like is coupled, in the imaging apparatus 1. Accordingly, stable coupling can be ensured while the imaging apparatus 1 is coupled to a tripod or the like, with the center of gravity located on the axis of the coupling protrusion.

Operation parts 77, 77, and 77 and operation parts 78, 78, and 78 are respectively disposed in the button disposition parts 16a, 16a, and 16a formed in the side part 16 and the button disposition parts 17a, 17a, and 17a formed in the lower part 17 of the frame 15 of the housing 4, via, for example, a circuit board (not shown) (see FIG. 2). The operation parts 77, 77, and 77 and the operation parts 78, 78, and 78 are respectively connected to the main substrates 58, 58, and 58 through a circuit board, a wiring board (not shown), or the like.

The operation parts 77, 77, 77, 78, 78, and 78 are buttons for, for example, displaying a menu showing functions that can be performed in the imaging apparatus 1, selecting a menu, and switching menus.

The operation parts 77, 77, and 77 are disposed while being inserted into the button disposition holes 23a, 23a, and 23a formed in the side part 23 of the rear panel 6, respectively. In addition, the operation parts 78, 78, and 78 are disposed while being inserted into the button disposition holes 24a, 24a, and 24a formed in the lower part 24 of the rear panel 6, respectively (see FIG. 2).

A display panel 79 is disposed between the imaging element 42 and the rear panel 6. The display panel 79 is positioned such that the display surface thereof faces the light transmission part 22 of the rear panel 6 (see FIG. 3). For example, a liquid crystal panel is used as the display panel 79. The display panel 79 is connected to the main substrates 58, 58, and 58 through a wiring board or the like (not shown).

When the imaging button 27 is operated to start imaging operation in the imaging apparatus 1 configured as described above, an image (optical image) of a subject enters the imaging element 42 through the lenses 38, 38, . . . of the lens unit 36. Then, the imaging element 42 performs photoelectric conversion of the image of the subject incident on the imaging element 42 to generate an image. At the time of capturing an image, an image of the subject is displayed on the display panel 79. Thus, an image capturing person can capture an image while visually confirming the image displayed on the display panel 79. Furthermore, it is possible to display a captured image, a menu, or the like on the display panel 79 when, for example, no image is being captured.

As described above, a 1-inch (13.2 mm×8.8 mm) imaging element is used as the imaging element 42. The total number of pixels is approximately 21 million, and the number of effective pixels is approximately 15.6 million. However, an imaging element having a size corresponding to, for example, 1/1.7 type or APS-C type may be used as the imaging element 42.

The number of pixels of the imaging element 42 increases as a result of using an imaging element having a size corresponding to 1/1.7 type or APS-C type as the imaging element 42 as described above. It is thus possible to improve the image quality of a captured image or video.

Furthermore, the optical system including the lenses 38, 38, . . . used in the imaging apparatus 1 is defined as an optical system with, for example, a maximum aperture of 4.0, a focal length of 7.7 mm, and a 35 mm equivalent focal length of 24 mm.

### SUMMARY

As described above, the lens unit 36, the battery attachment part 65, the imaging element 42, and the display panel 79 are arranged side by side or separately from each other in the optical axis direction of the lenses 38, 38, . . . in the imaging apparatus 1. Furthermore, the main substrates 58, 58, and 58, the lenses 38, 38, . . . , and the antenna substrate 44 are arranged side by side or separately from each other in the arrangement direction orthogonal to the optical axis direction.

Thus, the imaging apparatus 1 includes the main substrates 58, 58, and 58 and the antenna substrate 44 which are different types of substrates. In addition, the main substrates 58, 58, and 58, the lenses 38, 38, . . . , and the antenna substrate 44 are arranged side by side or separately from each other in a direction orthogonal to a direction in which the lens unit 36, the battery attachment part 65, the imaging element 42, and the display panel 79 are arranged side by side or separately from each other. As a result, it is possible to achieve miniaturization while ensuring high functionality.

Furthermore, the main substrates 58, 58, and 58 and the antenna substrate 44 are disposed opposite to each other across the lenses 38, 38, . . . . Thus, the main substrates 58, 58, and 58 and the antenna substrate 44 are disposed separately from each other, so that the mutual influence of noise is reduced. It is thus possible to miniaturize the imaging apparatus 1 while reducing the influence of noise between the main substrates 58, 58, and 58 and the antenna substrate 44.

Moreover, provided is the housing 4 formed in a frame shape, in which at least the lens unit 36, the imaging element 42, the main substrates 58, 58, and 58, and the antenna substrate 44 are disposed.

Thus, the lens unit 36, the imaging element 42, the main substrates 58, 58, and 58, and the antenna substrate 44 are disposed inside the housing 4 formed in a frame shape to enhance strength. Therefore, it is possible to ensure a high protection function for the lens unit 36, the imaging element 42, the main substrates 58, 58, and 58, and the antenna substrate 44.

Moreover, the microphones 51 and 51 are disposed below the lenses 38, 38, . . . , and the speaker 50 is disposed above the lenses 38, 38, . . . . As a result, the microphones 51 and 51 and the speaker 50 are disposed opposite to each other across the lenses 38, 38, . . . .

Thus, the microphones 51 and 51 and the speaker 50 are located separately from each other, so that the mutual influence of noise is reduced. It is thus possible to miniaturize the imaging apparatus 1 while ensuring a favorable audio input state and output state.

Furthermore, the microphones 51 and 51 and the speaker 50 are disposed separately from each other in a direction orthogonal to both the optical axis direction and the arrangement direction.

Thus, the microphones 51 and 51 and the speaker 50 are disposed at positions orthogonal to the main substrates 58, 58, and 58 and the antenna substrate 44. This reduces the influence of the noise of the main substrates 58, 58, and 58 and the antenna substrate 44 on the microphones 51 and 51 and the speaker 50. It is thus possible to miniaturize the imaging apparatus 1 while improving sound quality.

Moreover, the power button 26 and the imaging button 27 functioning as operation parts and the operation parts 78, 78, and 78 functioning as operation parts are disposed on both sides of the lenses 38, 38, . . . in a direction (vertical direction) orthogonal to both the optical axis direction and the arrangement direction.

Thus, the power button 26, the imaging button 27, and the operation parts 78, 78, and 78 are disposed at positions orthogonal to the main substrates 58, 58, and 58, and the antenna substrate 44. As a result, the power button 26, the imaging button 27, and the operation parts 78, 78, and 78 do not interfere with the main substrates 58, 58, and 58 and the antenna substrate 44. Accordingly, there is a lot of flexibility with positions for disposing the power button 26, the imaging button 27, and the operation parts 78, 78, and 78. This ensures good operability of the power button 26, the imaging button 27, and the operation parts 78, 78, and 78.

<One Embodiment of Imaging Apparatus>

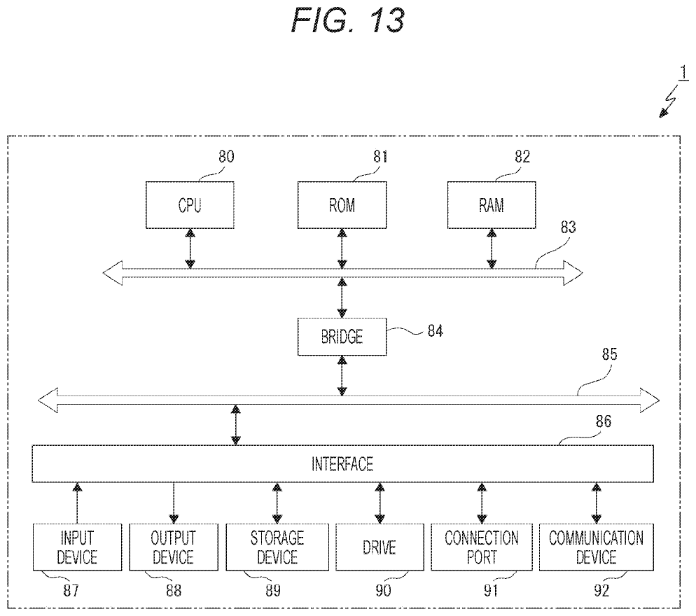

The following describes a hardware configuration of a still camera (digital still camera) according to an embodiment of the imaging apparatus 1 and operation of the imaging apparatus 1 (see FIG. 13).

The imaging apparatus 1 includes a central processing unit (CPU) 80, a read only memory (ROM) 81, a random access memory (RAM) 82, a first bus 83, a bridge 84, a second bus 85, an interface 86, an input device 87, an output device 88, a storage device 89, a drive 90, a connection port 91, and a communication device 92. The CPU 80 is, for example, a microprocessor, and functions as an arithmetic processing unit to control the overall operation of the imaging apparatus 1 on the basis of various programs.

The ROM 81 stores the programs to be executed by the CPU 80, operation parameters, or the like. The RAM 82 temporarily stores, for example, a program to be used in operation of the CPU 80 or parameters that change during the operation as appropriate. The CPU 80, the ROM 81, and the RAM 82 are interconnected by the first bus 83 including a CPU bus or the like. Furthermore, the first bus 83 is connected to the second bus 85 via the bridge 84, and the interface 86 is connected to the second bus 86.

The interface 86 enables unidirectional or bidirectional signal input/output between the input device 87, the output device 88, the storage device 89, the drive 90, the connection port 91, and the communication device 92. The input device 87 includes an input unit and an input control circuit unit. The input unit receives an input. The input control circuit unit generates an input signal on the basis of the input, and outputs the input signal to the CPU 80. Examples of input units provided in the imaging apparatus 1 include the power button 26, the imaging button 27, the microphones 51 and 51, the operation parts 77, 77, and 77, and the operation parts 78, 78, and 78. The output device 88 includes an output unit and an output control circuit unit. The output unit outputs images and sounds. The output control circuit unit generates an output signal on the basis of a command from the CPU 80, and transmits the output signal to the output unit. Examples of output units provided in the imaging apparatus 1 include the speaker 50 and the display panel 79. The storage device 89 is a device for storing data. The storage device 89 stores the programs to be executed by the CPU 80 and various data.

The drive 90 is a reader/writer for a recording card. The drive 90 may include, for example, a recording unit that records data on a recording card, a reading unit that reads data from the recording card, and a deletion unit that deletes data recorded on the recording card. Data read from a recording card by the drive 90 are output to the RAM 81. The connection port 91 is a bus for connection with an external device. Examples of the connection port 91 provided in the imaging apparatus 1 include the microphone terminal 57 and the connection terminals 60 and 60. The communication device 92 is a device including a communication unit for connection with a network compatible with, for example, a wireless local area network (LAN) or long term evolution (LTE). The imaging apparatus 1 includes, for example, the antenna substrate 44 as a communication unit.

In the imaging apparatus 1 configured as described above, predetermined processing is performed on an image signal subjected to photoelectric conversion by the imaging element 42, so that the image signal is displayed as an image or video on the display panel 79, and is also recorded in a recording unit such as a recording card inserted in the card slot 61. At this time, the image or video is also displayed on the display unit of an external device such as a mobile phone or a remote control device through wireless communication or the like.

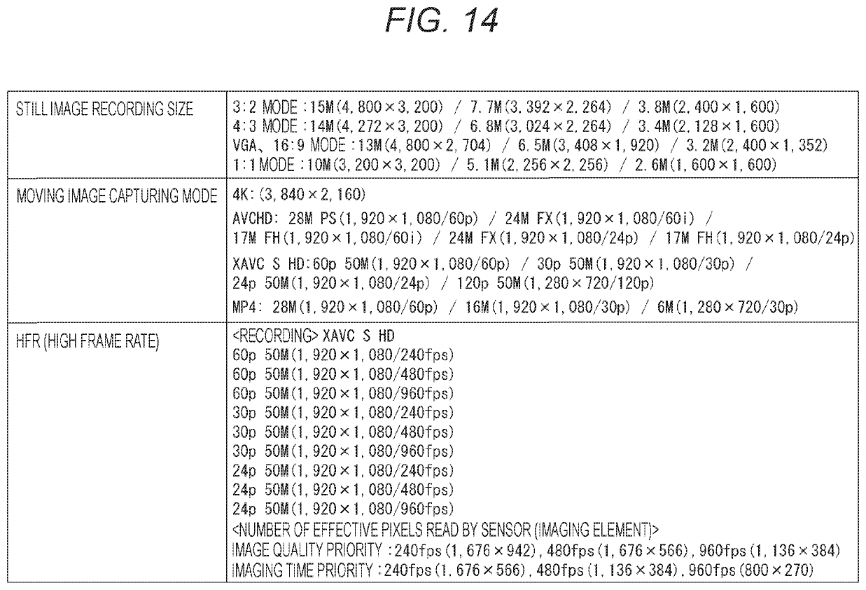

As described above, the imaging apparatus 1 uses, for example, the 1-inch imaging element 42 with approximately 21 million total pixels and approximately 15.6 million effective pixels. Recording is performed in a recording unit such as a recording card on the basis of a size, a rate, and the like according to a difference in the aspect ratio of a screen, a recording mode, or the like (see FIG. 14).

However, basically, an image or video is displayed as a result of transmitting an image signal to the display panel 79 or the display unit of an external device, with the number of pixels and at a frame rate corresponding to a specification lower than the specification shown in FIG. 14. Furthermore, in the case of a moving image, there are also cases where thinned frames are encoded by the joint photographic experts group (JPEG) method, the encoded data are transmitted to an external device by wireless communication, and the transmitted data are decoded by the external device and displayed on the display unit.

<Configuration and the Like of Cable Holder>

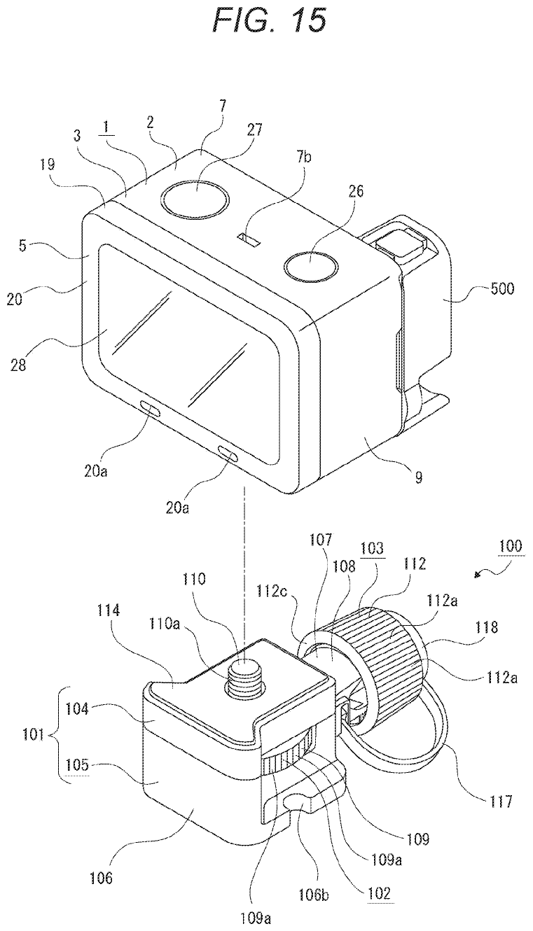

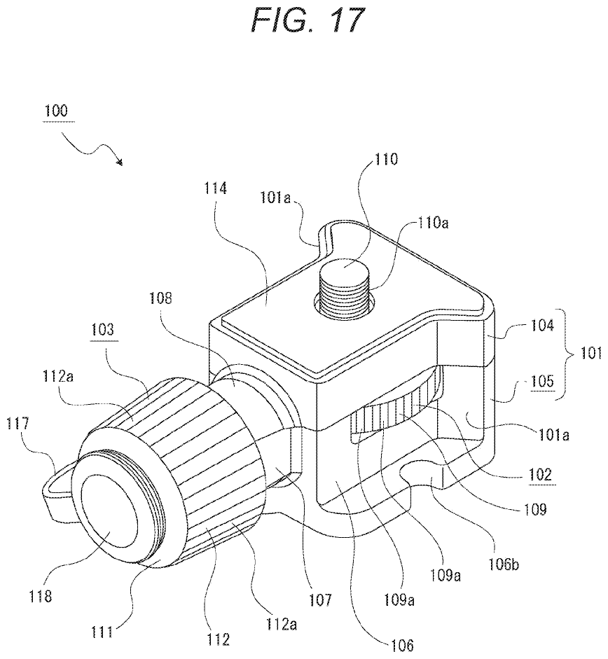

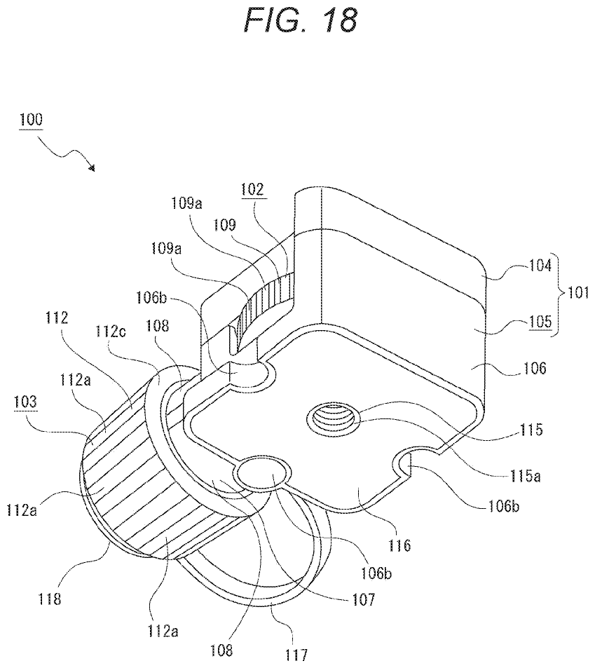

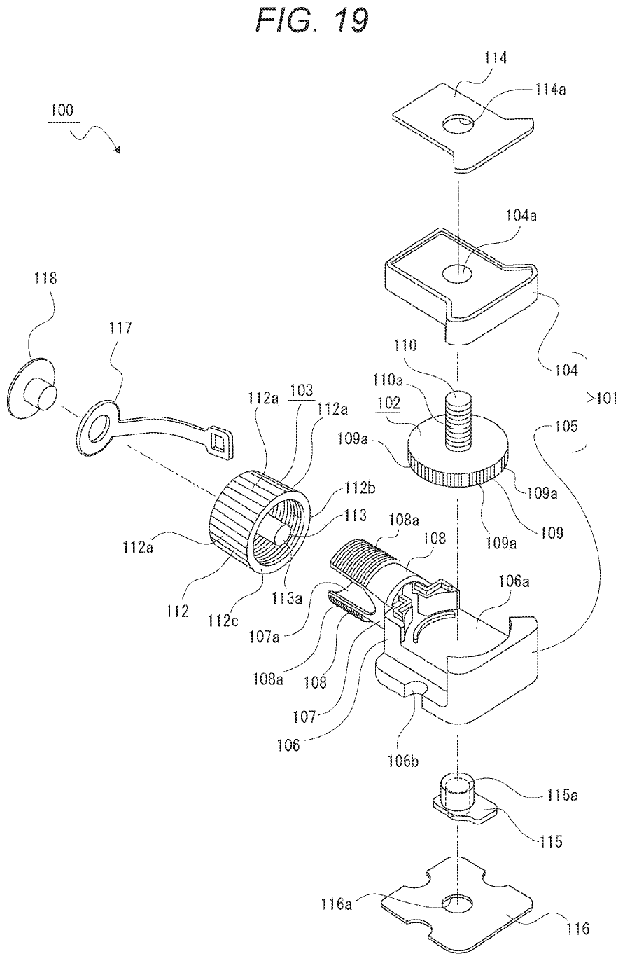

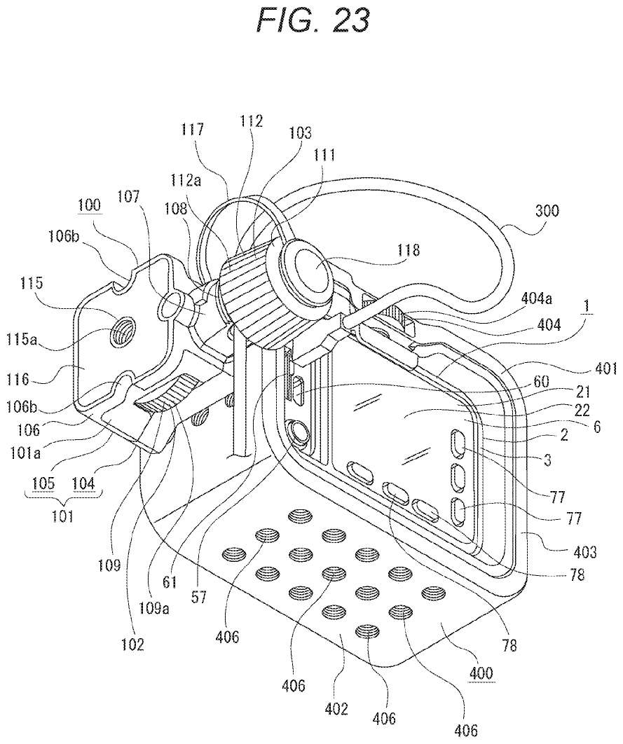

Next, a cable holder 100 will be described (see FIGS. 15 to 25).

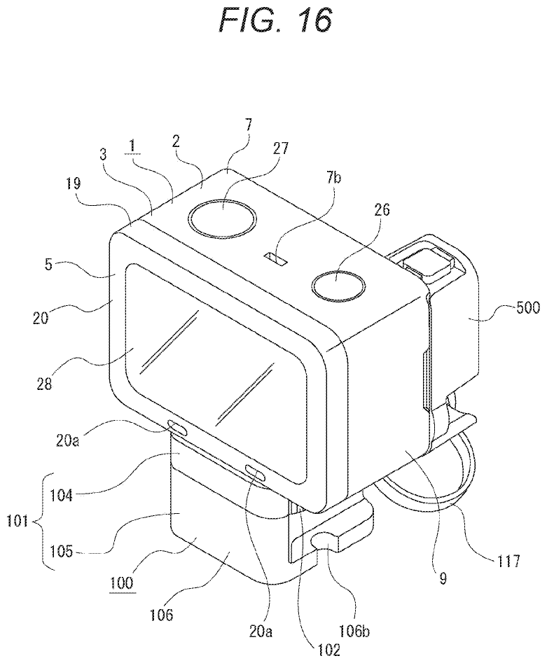

The cable holder 100 is attachable to/detachable from the imaging apparatus 1 or the like (see FIGS. 15 and 16). The cable holder 100 includes a main body case 101, a coupling member 102, and a cap 103. The main body case 101 is formed in a substantially block shape. The coupling member 102 is rotatably supported by the main body case 101. The cap 103 is attachable to/detachable from the main body case 101 (FIGS. 15, 17, 18, and 19).

The main body case 101 includes a first case 104 and a second case 105 coupled to each other. The main body case 101 includes gripping surfaces 101a and 101a formed as a pair of inclined surfaces. Both the left and right side surfaces, except the lower parts thereof, of an end of the main body case 101 opposite to an end to which the cap 103 is attached form the pair of inclined surfaces gradually separated from each other toward the end to which the cap 103 is attached.

The cable holder 100 is gripped by a user when being attached to/detached from the imaging apparatus 1 or the like. Here, the gripping surfaces 101a and 101a are formed as inclined surfaces that are gradually separated from each other toward the end to which the cap 103 is attached. Therefore, it is possible for the user to easily and stably attach/detach the cable holder 100 to/from the imaging apparatus 1 or the like by gripping the cable holder 100 with fingers on the gripping surface 101a and 101a.

The first case 104 is formed in a shape with a vertical thickness smaller than that of the second case 105. A protrusion insertion hole 104a is formed in the center of the first case 104 such that the protrusion insertion hole 104a is vertically penetrated.

The second case 105 includes a base 106 and a holding protrusion 107. The base 106 is coupled to the first case 104. The holding protrusion 107 protrudes from the base 106.

A support recess 106a is formed in the upper end part of the base 106. The support recess 106a opens upward and to the left and right. Positioning recesses 106b, 106b, and 106b are formed in the lower end part of the base 107 such that positioning recesses 106b, 106b, and 106b are separated from each other in the circumferential direction. The positioning recesses 106b, 106b, and 106b open outward, upward, and downward on the left and right sides, or downward.

The holding protrusion 107 protrudes from the base 106 in a direction orthogonal to a direction in which the first case 104 and the second case 105 are coupled to each other. A holding space 107a is formed in the holding protrusion 107. The holding space 107a opens to the left and right, and also opens in the direction in which the holding protrusion 107 protrudes from the base 106. Parts of the holding protrusion 107, which are located above and below the holding space 107a, are respectively provided as attachment piece parts 108 and 108. The attachment piece parts 108 and 108 are formed in a substantially arc shape that is convex outward, with the same size and the same curvature. Spiral grooves 108a and 108a are formed in the outer surfaces of the end parts of the attachment piece parts 108 and 108.

The coupling member 102 includes a disc-like operation dial 109 and a coupling shaft 110. The coupling shaft 110 has a round shaft shape, and protrudes from the center of the operation dial 109. A plurality of knurls 109a, 109a, . . . is formed in a series on the outer peripheral surface of the operation dial 109 in the circumferential direction. The central axis of the coupling shaft 110 is aligned with the central axis of the operation dial 109. The outer peripheral surface of the coupling shaft 110 is formed as a screwing portion 110a.

The cap 103 includes a disc-like base 111, an attachment part 112, and a pressing protrusion 113. The attachment part 112 has a substantially cylindrical shape, and protrudes from the outer peripheral part of the base 111. The pressing protrusion 113 protrudes from the center of the base 111 in the same direction as the attachment part 112. A plurality of knurls 112a, 112a, . . . is formed in a series on the outer peripheral surface of the attachment part 112 in the circumferential direction. A spiral groove 112b is formed in the inner peripheral surface of the attachment part 112. The pressing protrusion 113 is located inside the attachment part 112 such that an end surface 113a of the pressing protrusion 113 and an end surface 112c of the attachment part 112 are located at substantially the same distance from the base 111 in the direction in which the pressing protrusion 113 and the attachment part 112 protrude from the base 111.

The attachment part 112 of the cap 103 is rotationally operated to screw the spiral groove 112b onto the spiral grooves 108a and 108a of the attachment piece parts 108 and 108, so that the cap 103 is attached to the main body case 101. While the cap 103 is kept attached to the main body case 101, the pressing protrusion 113 is located in the holding space 107a of the holding protrusion 107.

Furthermore, the cap 103 is removed from the main body case 101 by rotation operation in a direction opposite to the direction in which the cap 103 is attached to the attachment part 112.

A first reinforcing plate 114 is attached to the upper surface of the first case 104. A through hole 114a is formed in the first reinforcing plate 114. While the first reinforcing plate 114 is kept attached to the first case 104, the through hole 114a is located directly above the protrusion insertion hole 104a of the first case 104.

A fastening member 115 is attached to the lower surface of the second case 105 while being disposed inside the second case 105. The fastening member 115 includes a screwing cylindrical part 115a with a cylindrical shape. The screwing cylindrical part 115a is vertically penetrated. A spiral groove is formed in the inner surface of the screwing cylindrical part 115a.

A second reinforcing plate 116 is attached to the lower surface of the second case 105 such that the second reinforcing plate 116 holds the fastening member 115 from below. A through hole 116a is formed in the second reinforcing plate 116. While the second reinforcing plate 116 is kept attached to the second case 105, the through hole 116a is located directly below the screwing cylindrical part 115a of the fastening member 115.

The second case 105 of the main body case 101 and the cap 103 are connected by a connecting belt 117. The connecting belt 117 is highly flexible. One end of the connecting belt 117 is coupled to the base end of the holding protrusion 107 of the second case 105. The other end of the connecting belt 117 is coupled to the base 111 of the cap 103. A fastener 118 is attached to the base 111 of the cap 103 in such a way as to hold the other end of the connecting belt 117. Thus, the fastener 118 prevents the connecting belt 117 from coming off the cap 103.

The coupling member 102 is disposed such that the operation dial 109 is inserted into the support recess 106a of the second case 105. As a result of vertically coupling the first case 104 and the base 106 of the second case 105, with the operation dial 109 inserted in the support recess 106a, the coupling shaft 110 of the coupling member 102 is inserted into the protrusion insertion hole 104a of the first case 104 and the through hole 114a of the first reinforcing plate 114. A part of the coupling shaft 110 protrudes upward from the first reinforcing plate 114.

While being kept inserted in the support recess 106a, the operation dial 109 partially protrudes leftward and rightward from the main body case 101. Therefore, a user can rotate the coupling member 102 by operating the operation dial 109 with fingers on parts of the operation dial 109 protruding leftward and rightward from the main body case 101. At this time, the knurls 109a, 109a, . . . formed on the outer peripheral surface of the operation dial 109 prevent the operation dial 109 from being slippery when the operation dial 109 is operated with fingers. Thus, it is possible to ensure good operability of the coupling member 102.

The cable holder 100 is attached to, for example, the imaging apparatus 1 (see FIGS. 15 and 16). The operation dial 109 is rotationally operated so as to screw the screwing portion 110a of the coupling shaft 110 of the coupling member 102 into the spiral groove of the coupling part 76a formed in the connecting member 76 of the imaging apparatus 1. Thus, the cable holder 100 is attached to the imaging apparatus 1.

While the cable holder 100 is kept attached to the imaging apparatus 1, the coupling shaft 110 is inserted in the protrusion through hole 8a formed in the lower surface 8 of the outer housing 3, the insertion hole 12a formed in the bottom plate 12 of the housing 4, and the coupling part 76a of the connecting member 76, and the upper surface of the first reinforcing plate 114 is in contact with the lower surface of the outer housing 3.

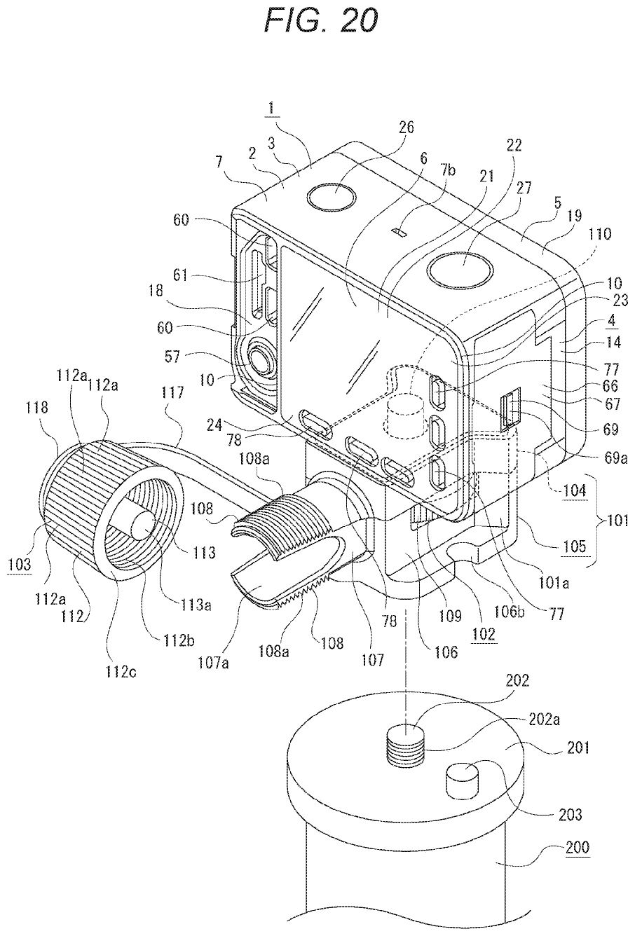

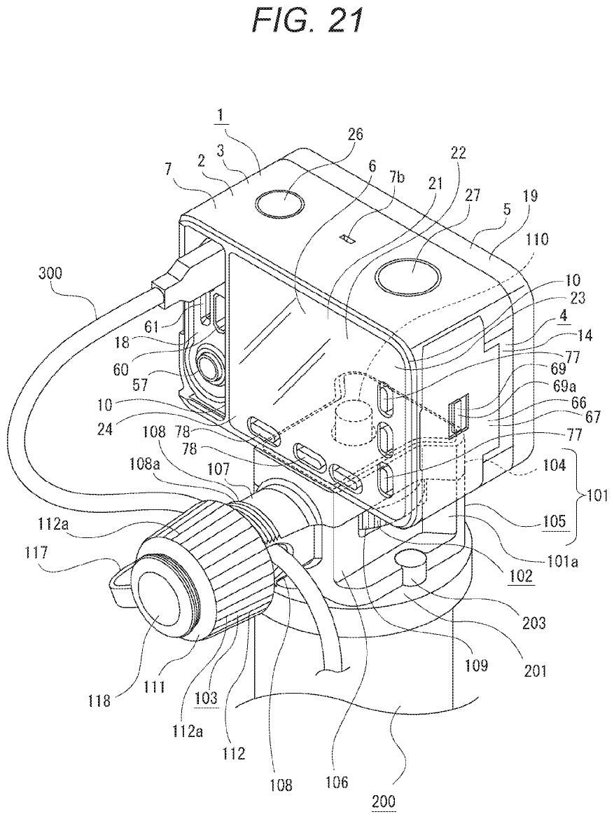

The cable holder 100 is also attached to, for example, a tripod 200 (see FIGS. 20 and 21). A pedestal 201 is provided on the upper end of the tripod 200. A coupling protrusion 202 and a positioning protrusion 203 protrude upward from the upper surface of the pedestal 201. A spiral groove 202a is formed in the outer peripheral surface of the coupling protrusion 202.

The coupling protrusion 202 is inserted into the through hole 116a of the second reinforcing member 116, and the spiral groove 202a is screwed into the screwing cylindrical part 115a of the fastening member 115. Thus, the cable holder 100 is attached to the tripod 200. At this time, the positioning protrusion 203 of the tripod 200 is inserted into any of the positioning recesses 106b of the main body case 101 so as to determine the position of the cable holder 100 with respect to the tripod 200. It is possible to attach the cable holder 100 to the tripod 200 in three different directions by inserting the positioning protrusion 203 into any of the positioning recesses 106b in accordance with the orientation of the cable holder 100 with respect to the tripod 200. Therefore, a direction in which a cable 300 is to be laid can be changed according to the orientation of attachment of the cable holder 100 with respect to the tripod 200. It is thus possible to improve the usability of the cable holder 100.

While the cable holder 100 is kept attached to the tripod 200, the lower surface of the second reinforcing plate 116 is in contact with the upper surface of the pedestal 201.

There are cases where, for example, the cable 300 may be connected to the microphone terminal 57 or the connection terminal 60 or 60 in the imaging apparatus 1. In such a case, it is possible to hold the connected cable 300 by the cable holder 100 (see FIG. 21). One end of the cable 300 is connected to the imaging apparatus 1, and the other end of the cable 300 is connected to an external device such as a display device or a sound collecting device.

In a case where the cable 300 is held by the cable holder 100, the cap 103 is first rotationally operated and removed from the holding protrusion 107 of the main body case 101 (see FIG. 20). Next, the cable 300 is inserted between the attachment piece parts 108 and 108. Then, the cap 103 is rotationally operated to be attached to the attachment piece parts 108 and 108.

The knurls 112a, 112a, . . . formed on the outer peripheral surface of the attachment part 112 of the cap 103 prevent the cap 103 from being slippery when the cap 103 is rotationally operated with fingers. Thus, it is possible to ensure good operability of the cap 103.

The cap 103 is rotated to a position where the end surface 112c of the attachment part 112 and the end surface 113a of the pressing protrusion 113 come into contact with the cable 300, so that the cable 300 is held by the cable holder 100. While the cable 300 is held by the cable holder 100, the end surface 112c of the attachment part 112 and the end surface 113a of the pressing protrusion 113 are in contact with the cable 300. Therefore, the cable 300 is held by the attachment part 112 and the pressing protrusion 113, so that the cable 300 is less likely to be moved in the longitudinal direction with respect to the cable holder 100. As a result, the cable 300 can be stably held.

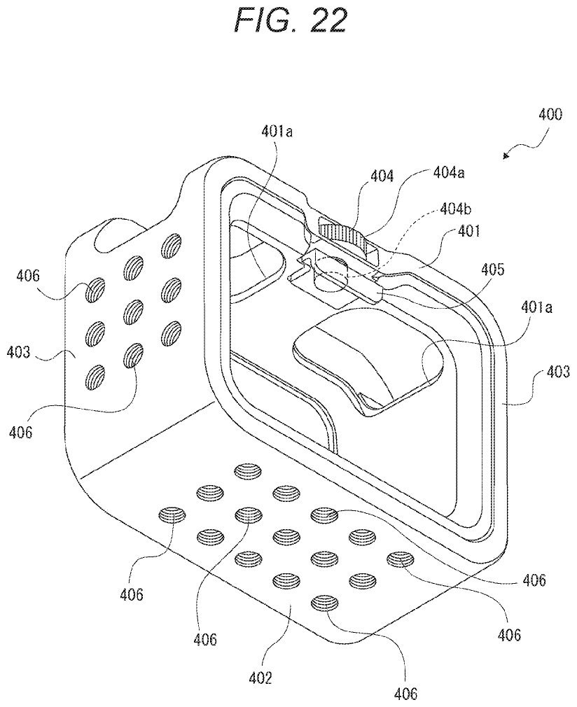

The cable holder 100 is also attached to, for example, a rig 400 capable of expanding necessary functions (see FIGS. 22 to 25). The rig 400 is formed in a frame shape with a width in the front-back direction larger than the width of the imaging apparatus 1 in the front-back direction. The rig 400 includes an upper plate 401, a lower plate 402, and side plates 403 and 403.

Operation holes 401a and 401a are formed in the upper plate 401 such that the operation holes 401a and 401a are separated from each other in the left-right direction. A fixing dial 404 is rotatably supported at the rear end of the upper plate 401. The fixing dial 404 includes a disk-like operation part 404a and a support shaft 404b protruding downward from the center of the operation part 404a. A part of the support shaft 404b protrudes downward from the upper plate 401.

A fixing plate 405 is supported by the part of the support shaft 404b protruding downward from the upper plate 401. The fixing plate 405 is vertically movable by rotation of the fixing dial 404.

A plurality of screw holes 406, 406, . . . is formed in the upper plate 401, the lower plate 402, and the side plates 403 and 403.

The imaging apparatus 1 is inserted into the rig 400 from the front. When the operation part 404a is operated to rotate the fixing dial 404 while the imaging apparatus 1 is kept inserted in the rig 400, the fixing plate 405 is moved downward and pressed against the upper surface of the imaging apparatus 1. As a result, the imaging apparatus 1 is held while being fixed to the rig 400. While the imaging apparatus 1 is held by the rig 400, the power button 26 and the imaging button 27 can be operated via the operation holes 401a and 401a formed in the upper plate 401.

The cable holder 100 is attached to the rig 400 by the screwing of the screwing portion 110a of the coupling shaft 110 into the screw hole 406. Therefore, it is possible to cause the cable 300 to be held by the cable holder 100, by inserting the cable 300 connected to the microphone terminal 57 or the connection terminal 60 or 60 of the imaging apparatus 1 into the holding space 107a of the holding protrusion 107 while the cable holder 100 is kept attached to the rig 400.

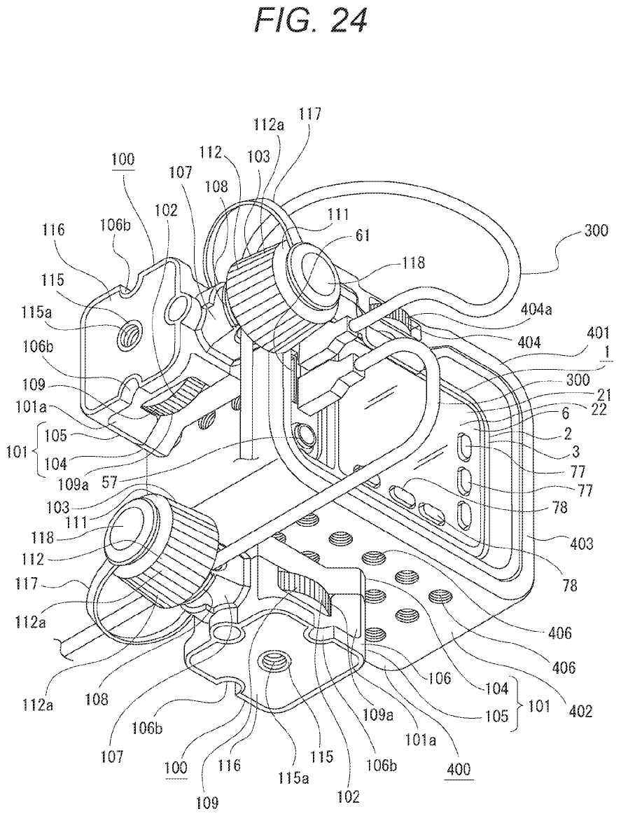

Furthermore, the plurality of screw holes 406, 406, . . . formed in the rig 400 enables a plurality of the cable holders 100, 100, . . . to be attached to the rig 400, at necessary positions (see FIG. 24).

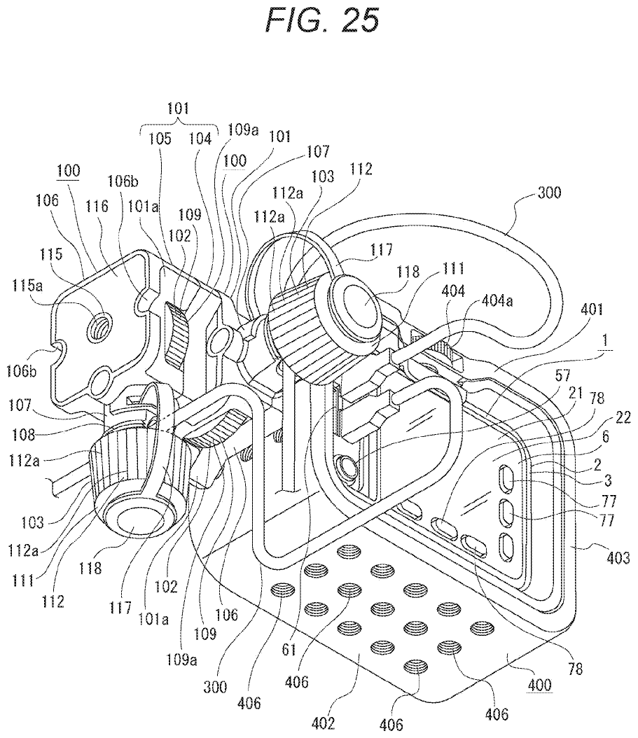

Note that the cable holders 100, 100, . . . may be attached to the rig 400 at different positions (see FIG. 24), or may be attached while being stacked (see FIG. 25). The mode in which the cable holders 100, 100, . . . are attached while being stacked can also be applied to the mode of attaching the cable holders 100, 100, . . . to the imaging apparatus 1 or the tripod 200.

As described above, the cable holder 100 is attachable to the imaging apparatus 1 or the rig 400, and can hold the cable 300.

Therefore, the cable 300 can be held stably in a small space at a position close to the imaging apparatus 1.

Furthermore, the cable holder 100 can be attached to the imaging apparatus 1 or the rig 400 in any direction (see FIG. 24). Thus, it is possible to hold the cable 300 without putting an unnecessary load on the cable 300. As a result, it is possible to stably hold the cable 300 without causing damage or deformation of the cable 300, and also possible to perform wiring using the cable 300 in a desired direction.

Moreover, the cable holder 100 includes the coupling shaft 110 having an external thread and the screwing cylindrical part 115a having an internal thread. Therefore, the imaging apparatus 100 can be attached to the imaging apparatus 1 or the rig 400 while being attached to the tripod 200.

This improves the flexibility and versatility of the imaging mode. It is thus possible to capture images by using the appropriate imaging apparatus 1 depending on needs in various imaging scenes.

Furthermore, it is possible to attach a plurality of the cable holders 100, 100, . . . to the rig 400 to hold a plurality of the cables 300, 300, . . . . Thus, the cables 300, 300, . . . can be held together in a small space.

Note that although an example of the cable holder 100 including the screwing cylindrical part 115a to which the coupling protrusion 202 of the tripod 200 is coupled has been described above, the cable holder 100 may be configured such that the cable holder 100 can be attached to, for example, an accessory shoe to be provided on the upper surface or the like of the imaging apparatus 1. In this case, the cable holder 100 just needs to include an attachment piece attachable to the accessory shoe, instead of the fastening member 115 including the screwing cylindrical part 115a.

Furthermore, the cable holder 100 may be configured such that the fastening member 115 can be exchanged with the attachment piece attachable to the accessory shoe. In this case, the mode of attaching the cable holder 100 increases, and the versatility and usability can be improved.

Note that while the cable 300 is connected to the imaging apparatus 1, a protector 500 may be attached to the terminal disposition part 108 of the imaging apparatus 1 (see FIGS. 15, 16, 23, 24, and 25). The protector 500 is formed in a frame shape and attached to the rear surface of the terminal disposition part 108.

The protector 500 can prevent a hand or the cable 300 from accidentally coming into contact with a recording card, and can protect the recording card, as a result of attaching the protector 500 to the terminal disposition part 108 in a case where, for example, the recording card inserted into the card slot 61 partially protrudes backward from the card slot 61.

Furthermore, attachment of the protector 500 to the terminal disposition part 108 increases the possibility that the cable 300 is inserted/removed along the protector 500 when connected to/disconnected from the microphone terminal 57 or the connection terminal 60 or 60. Therefore, the cable 300 is less likely to be diagonally inserted into/removed from the microphone terminal 57 or the connection terminal 60 or 60. As a result, the microphone terminal 57, the connection terminals 60 and 60, and the cable 300 are less likely to be subjected to an unnecessary load. It is thus possible to prevent damage or deformation of the microphone terminal 57, the connection terminals 60 and 60, and the cable 300.

<Present Technology>

The present technology can also adopt the following configurations.

(1)

An imaging apparatus including:

a lens unit that includes at least one lens;

an imaging element that performs photoelectric conversion of an optical image of a subject captured by the lens;

a battery attachment part to which a battery is attached;

a display panel on which an image or video is displayed;

a main substrate that controls at least the lens unit; and

an antenna substrate having a communication function,

in which the lens unit, the battery attachment part, the imaging element, and the display panel are arranged side by side or separately from each other in an optical axis direction of the lens, and

in a case where a direction orthogonal to the optical axis direction is defined as an arrangement direction, the main substrate, the lens, and the antenna substrate are arranged side by side or separately from each other in the arrangement direction.

(2)

The imaging apparatus according to (1) above, in which the main substrate and the antenna substrate are disposed opposite to each other across the lens.

(3)

The imaging apparatus according to (1) or (2) above, in which

a thickness direction of the main substrate is aligned with the arrangement direction.

(4)

The imaging apparatus according to (3) above, in which

a plurality of the main substrates is arranged in the arrangement direction, and

the plurality of main substrates is connected by a flexible printed wiring board.

(5)

The imaging apparatus according to (4) above, in which

a connection terminal is disposed between the plurality of main substrates positioned to face each other.

(6)

The imaging apparatus according to (5) above, in which

a plurality of the connection terminals is disposed in a direction orthogonal to the arrangement direction.

(7)

The imaging apparatus according to (5) or (6) above, in which

a case body is provided in which the plurality of main substrates and a plurality of the connection terminals are disposed, and

a board terminal unit is formed as a result of disposing at least the plurality of main substrates and the plurality of connection terminals in the case body.

(8)

The imaging apparatus according to (7) above, in which

an electrode terminal to which a terminal of the battery is connected is attached to the case body.

(9)

The imaging apparatuses according to (1) to (8) above, in which

a housing is provided in which at least the lens unit, the imaging element, the main substrate, and the antenna substrate are disposed, and

the housing is formed in a frame shape.

(10)

The imaging apparatus according to any one of (1) to (9) above, in which

the battery is formed in a substantially rectangular parallelepiped shape, with a size in a thickness direction smaller than a size in a length direction and a size in a width direction, and

the battery is attached to the battery attachment part such that the thickness direction is aligned with the optical axis direction.

(11)

The imaging apparatus according to (10) above, in which

a housing is provided which has a battery insertion hole for insertion or removal of the battery, and

the battery is inserted into or removed from the battery insertion hole in the arrangement direction.

(12)

The imaging apparatus according to any one of (1) to (11) above, in which

a microphone through which a sound is input and a speaker that outputs a sound are provided, and

the microphone and the speaker are disposed opposite to each other across the lens.

(13)

The imaging apparatus according to (12) above, in which

the microphone and the speaker are disposed separately from each other in a direction orthogonal to both the optical axis direction and the arrangement direction.

(14)

The imaging apparatus according to any one of (1) to (13) above, in which

operation parts that are used to perform predetermined functions are disposed on both sides of the lens in a direction orthogonal to both the optical axis direction and the arrangement direction.

(15)

The imaging apparatus according to any one of (1) to (14) above, in which

a coupling part is formed to which a coupling protrusion of a tripod is coupled, and

the center of gravity is located on a central axis of the coupling part.

(16)

The imaging apparatus according to any one of (1) to (15) above, in which

an imaging element having a size corresponding to 1/1.7 type or APS-C type is used as the imaging element.

### REFERENCE SIGNS LIST

1 Imaging apparatus
4 Housing
14a Battery insertion hole
36 Lens unit
38 Lens
42 Imaging element
44 Antenna substrate
50 Speaker
51 Microphone
52 Board terminal unit
53 Case body
57 Microphone terminal
58 Main substrate
59 Flexible printed wiring board
60 Connection terminal
62 Electrode terminal
65 Battery attachment part
76a Coupling part
77 Operation part
78 Operation part
79 Display panel
99 Battery
200 Tripod
202 Coupling protrusion

1. An imaging apparatus comprising:
a lens unit that includes at least one lens;
an imaging element that performs photoelectric conversion of an optical image of a subject captured by the lens;
a battery attachment part to which a battery is attached;
a display panel on which an image or video is displayed;
a main substrate that controls at least the lens unit; and
an antenna substrate having a communication function,
wherein the lens unit, the battery attachment part, the imaging element, and the display panel are arranged side by side or separately from each other in an optical axis direction of the lens, and
in a case where a direction orthogonal to the optical axis direction is defined as an arrangement direction, the main substrate, the lens, and the antenna substrate are arranged side by side or separately from each other in the arrangement direction.

2. The imaging apparatus according to claim 1, wherein
the main substrate and the antenna substrate are disposed opposite to each other across the lens.

3. The imaging apparatus according to claim 1, wherein
a thickness direction of the main substrate is aligned with the arrangement direction.

4. The imaging apparatus according to claim 3, wherein
a plurality of the main substrates is arranged in the arrangement direction, and
the plurality of main substrates is connected by a flexible printed wiring board.

5. The imaging apparatus according to claim 4, wherein
a connection terminal is disposed between the plurality of main substrates positioned to face each other.

6. The imaging apparatus according to claim 5, wherein
a plurality of the connection terminals is disposed in a direction orthogonal to the arrangement direction.

7. The imaging apparatus according to claim 5, wherein
a case body is provided in which the plurality of main substrates and a plurality of the connection terminals are disposed, and
a board terminal unit is formed as a result of disposing at least the plurality of main substrates and the plurality of connection terminals in the case body.

8. The imaging apparatus according to claim 7, wherein
an electrode terminal to which a terminal of the battery is connected is attached to the case body.

9. The imaging apparatus according to claim 1, wherein
a housing is provided in which at least the lens unit, the imaging element, the main substrate, and the antenna substrate are disposed, and
the housing is formed in a frame shape.

10. The imaging apparatus according to claim 1, wherein
the battery is formed in a substantially rectangular parallelepiped shape, with a size in a thickness direction smaller than a size in a length direction and a size in a width direction, and
the battery is attached to the battery attachment part such that the thickness direction is aligned with the optical axis direction.

11. The imaging apparatus according to claim 10, wherein
a housing is provided which has a battery insertion hole for insertion or removal of the battery, and
the battery is inserted into or removed from the battery insertion hole in the arrangement direction.

12. The imaging apparatus according to claim 1, wherein
a microphone through which a sound is input and a speaker that outputs a sound are provided, and
the microphone and the speaker are disposed opposite to each other across the lens.

13. The imaging apparatus according to claim 12, wherein
the microphone and the speaker are disposed separately from each other in a direction orthogonal to both the optical axis direction and the arrangement direction.

14. The imaging apparatus according to claim 1, wherein
operation parts that are used to perform predetermined functions are disposed on both sides of the lens in a direction orthogonal to both the optical axis direction and the arrangement direction.

15. The imaging apparatus according to claim 1, wherein
a coupling part is formed to which a coupling protrusion of a tripod is coupled, and
a center of gravity is located on a central axis of the coupling part.

16. The imaging apparatus according to claim 1, wherein
an imaging element having a size corresponding to 1/1.7 type or APS-C type is used as the imaging element.
